(19) United States
(12) Patent Application Publication
(10) Pub. No.: US 2014/0326083 A1
(43) Pub. Date: Nov. 6, 2014

(54) Targeting Systems and Methods for Frozen Aliquotter for Biological Samples

(71) Applicant: CryoXtract Instruments, LLC, Boston, MA (US)

(72) Inventors: Todd Basque, Danvers, MA (US); Larry Chin, Needham, MA (US); Timothy Looney, Tyngsboro, MA (US); Eric Weber, Groton, MA (US)

(73) Assignee: CryoXtract Instruments, LLC, Boston, MA (US)

(21) Appl. No.: 14/270,091

(22) Filed: May 5, 2014

Related U.S. Application Data
(60) Provisional application No. 61/819,554, filed on May 4, 2013.

(51) Int. Cl. G01N 1/08

(52) U.S. Cl. CPC G01N 1/08
USPC 73/864.45

(57) ABSTRACT

A system for taking frozen sample cores from frozen biological samples includes a coring bit mount adapted to hold a coring bit and a carriage supporting the coring bit mount. A drive system is adapted to produce relative movement between the carriage and the frozen biological samples for moving the coring bit along a path into the frozen biological samples. A cutting action motor is supported by the carriage and adapted to drive a cutting motion of the coring bit as the drive system drives the coring bit into the frozen biological samples. A targeting system is adapted to direct electromagnetic radiation onto one of the frozen biological samples when the sample is positioned in the path of the coring bit. The electromagnetic radiation is adapted to produce a display on the frozen biological sample indicating where the path of the coring bit intersects the frozen biological sample.

### CROSS-REFERENCE TO RELATED APPLICATION

The present application is a non-provisional of U.S. Provisional Application Serial 61/819,554, filed May 4, 2013, the content of which is incorporated herein by reference in its entirety for all purposes.

### FIELD OF THE INVENTION

The present invention relates generally to systems and methods for obtaining frozen samples from frozen biological specimens, and more particularly to systems and methods for ensuring the frozen samples are taken from desired locations of the frozen biological specimens.

### BACKGROUND

Biological samples are commonly preserved to support a broad variety of biomedical and biological research that includes but is not limited to translational research, molecular medicine, and biomarker discovery. Biological samples include any samples which are of animal (including human), plant, protozoal, fungal, bacterial, viral, or other biological origin. The biological samples may include frozen fluids (e.g., frozen liquids, frozen blood, frozen serum, etc.) and/or frozen tissues. For example, biological samples include, but are not limited to, organisms and/or biological fluids isolated from or excreted by an organism such as plasma, serum, urine, whole blood, cord blood, other blood-based derivatives, cerebral spinal fluid, mucus (from respiratory tract, cervical), ascites, saliva, amniotic fluid, seminal fluid, tears, sweat, any fluids from plants (including sap); cells (e.g., animal, plant, protozoal, fungal, or bacterial cells, including buffy coat cells; cell lysates, homogenates, or suspensions; microsomes; cellular organelles (e.g., mitochondria); stem cells; tumor cells; nucleic acids (e.g., RNA, DNA), including chromosomal DNA, mitochondrial DNA, and plasmids (e.g., seed plasmids); small molecule compounds in suspension or solution (e.g. small molecule compounds in DMSO); and other fluid-based biological samples. Biological samples may also include tissue specimens (e.g., muscle, fat, skin, etc.), tumors, bone/bone marrow, plants, and portions of plants (e.g., seeds).

Biobanks typically store these valuable samples in containers (e.g., well plates or arrays, tubes, vials, or the like) and cryopreserve them. Tubes, vials, and similar containers can be organized in arrays and can be stored in well plates, racks, divided containers, etc. Although some samples are stored at relatively higher temperatures (e.g., about −20 degrees centigrade), other samples are stored at much lower temperatures. For example some samples are stored in freezers at −80 degrees centigrade, or lower using liquid Nitrogen or the vapor phase above liquid Nitrogen) to preserve the biochemical composition and integrity of the frozen sample as close as possible to the in vivo state to facilitate accurate, reproducible analyses of the samples.

From time to time, it may be desirable to run one or more tests on a sample that has been frozen. For example, a researcher may want to perform tests on a set of samples having certain characteristics. A particular sample may contain enough material to support a number of different tests. In order to conserve resources, smaller samples known as aliquots are commonly taken from larger cryopreserved samples (which are sometimes referred to as parent samples) for use in one or more tests so the remainder of the parent sample will be available for one or more different future tests.

Biobanks have adopted different ways to address this need to provide sample aliquots. One option is to freeze a sample in large volume, thaw it when aliquots are requested and then refreeze any remainder of the parent sample for storage in the cryopreserved state until future aliquots are needed. This option makes efficient use of frozen storage space; yet this efficiency comes at the cost of sample quality. Exposing a sample repeatedly to freeze/thaw cycles can degrade the sample's critical biological molecules (e.g., RNA) and damage biomarkers, either of which could compromise the results of any study using data obtained from the damaged samples. In some cases, it may not be possible to re-freeze a specimen to re-access it in the future due to the loss of molecular integrity after it has been thawed even just once.

Another option is to freeze a sample in large volume, thaw it when an aliquot is requested, subdivide the remainder of the parent sample in small volumes to make additional aliquots for future tests and then refreeze these smaller volume aliquots to cryopreserve each aliquot separately until needed for a future test. This approach limits the number of freeze/thaw cycles to which a sample is exposed, but there is added expense associated with the larger volume of frozen storage space, labor, and larger inventory of sample containers (e.g. tubes, vials, or the like) required to maintain the cryopreserved aliquots. Moreover, the aliquots can be degraded or damaged by even a limited number freeze/thaw cycles.

Yet another approach is to divide a large volume sample into smaller volume aliquots before freezing them for the first time. This approach can limit the number of freeze thaw cycles to which a sample may be subjected to only one; yet, there are disadvantages associated with the costs of labor, frozen storage space, and sample container inventory requirements with this approach.

U.S. pre-grant publication 20090019877, filed Jan. 16, 2007, entitled Systems, Methods and Devices for Frozen Sample Distribution, the contents of which are hereby incorporated by reference, discloses a system for extracting frozen sample cores from a frozen biological sample without thawing the original (parent) sample. The system uses a drill including a hollow coring bit to take a frozen core sample from the original parent sample without thawing the parent sample. The frozen sample core obtained by the drill is used as the aliquot for the test. After the frozen core is removed, the remainder of the sample is returned to frozen storage in its original container until another aliquot from the parent sample is needed for a future test.

Commonly owned U.S. application No. 61/640,662, filed Apr. 30, 2012, U.S. application Ser. No. 13/489,234, filed Jun. 5, 2012, and U.S. application Ser. No. 13/844,156, filed Mar. 15, 2013, each of which are entitled Machine Vision System for Frozen Aliquotter for Biological Samples, the contents of which are each hereby incorporated by reference, disclose systems and methods that facilitate automatic recognition of whether or not a frozen sample contains any bores from previous extraction of one or more frozen sample cores as well as the positions of any such bores to implement automatic extraction of further frozen sample cores from the sample.

PCT application PCT/US2011/061214, filed Nov. 17, 2011, and U.S. provisional application 61/418,688, filed Dec. 1, 2010, both of which are entitled Apparatus and Methods for Aliquotting Frozen Samples, the contents of which are hereby incorporated by reference, disclose a method of obtaining an aliquot of a frozen sample using a coring device. The location of the coring is selected to be at a radial position where the concentration of a substance of interest in the frozen sample core is representative of the overall concentration of the substance in the parent sample.

U.S. Provisional Application No. 61/640,662 and U.S. application Ser. No. 13/489,234, the contents of which have already been incorporated by reference above, disclose a machine vision system for use with a system for obtaining frozen sample cores. The machine vision system includes a camera and a processor that receives image data from the camera to determine locations where frozen sample cores have already been taken from a frozen biological sample.

In pathology and biomedical research, tissue samples are often stored and sampled. Conventionally, the tissue samples were subjected to formalin fixation and embedded in paraffin or optimal cutting temperature compound (OCT). The embedded tissue is fixed to a slide sectioning device, such as a microtome or cryotome, and a thin section of the tissue is sliced off the top of the sample. The thin section is evaluated on a slide, and the area of interest of the sample (e.g., tumor) is identified (e.g., using a marking device to circle the area of interest). The slide is then lined up with the remainder of the tissue sample to determine where the area of interest is on the remaining tissue. The tissue sample is then moved to a processing or sampling area or device, and a sample is taken from the area of interest, typically by using a scalpel to cut the sample into pieces and extract a portion of tissue from the area of interest. One problem with formalin fixed embedded tissue is that biomarkers degrade and the research quality of the tissue is negatively affected by the fixation process. Thus, the use of frozen tissue is desirable over fixed material. However, the frozen tissue samples are typically stored in a variety of containers and processed with methods that require thawing of the samples to obtain portions of tissue from the areas of interest. The frozen tissue samples must still be sectioned for a slide and then moved to a sampling device. The variety of containers used to store a tissue sample, as well as the multiple apparatuses and fixtures that are needed to determine the area of interest and to sample a tissue sample, complicate the process.

The present inventors have developed systems and methods, which will be described below, that improve the ability to provide frozen aliquots from a frozen biological sample (e.g., frozen fluid and/or frozen tissue samples) using a system that extracts frozen sample cores from frozen biological samples without thawing the original (parent) samples.

### SUMMARY

In one aspect, a system for taking frozen sample cores from frozen biological samples generally comprises a coring bit mount adapted to hold a coring bit and a carriage supporting the coring bit mount. A drive system is adapted to produce relative movement between the carriage and the frozen biological samples for moving the coring bit along a path into the frozen biological samples. A cutting action motor is supported by the carriage and adapted to drive a cutting motion of the coring bit as the drive system drives the coring bit into the frozen biological samples to obtain a frozen sample core. A targeting system is adapted to direct electromagnetic radiation onto one of the frozen biological samples when said sample is positioned in the path of the coring bit. The electromagnetic radiation is adapted to produce a display on the frozen biological sample indicating where the path of the coring bit intersects the frozen biological sample.

In another aspect, a method of taking frozen sample cores from frozen biological samples using a system that drives one or more coring bits into the samples and then withdraws the one or more coring bits from the samples while a frozen sample core is retained in the one or more coring bits generally comprises positioning one of the frozen biological samples into a coring bit path along which the system moves the one or more coring bits. Electromagnetic radiation is directed onto the frozen biological sample. The electromagnetic radiation is adapted to produce a display on the frozen biological sample indicating a position on the frozen sample where the coring bit path intersects the frozen biological sample. The position where the coring bit path intersects the frozen biological sample, as indicated by the display, is confirmed as being at a location on the sample from which a frozen sample core is desired. The coring bit is driven into the frozen sample along the coring bit path. The coring bit is withdrawn from the frozen sample while a frozen sample core is retained in the coring bit.

In another aspect, a single-use coring probe for collecting a frozen aliquot from a frozen biological sample generally comprises a hollow coring bit for taking a frozen sample core from the frozen biological sample. An ejector is adapted to eject the frozen sample core taken by the hollow coring bit from the hollow coring bit. The ejector is movable from a retracted position to an extended position and operable to push a frozen sample core out of the coring bit as it moves from the retracted position to the extended position. A locking mechanism is adapted to discourage re-use of the single-use coring probe. The locking mechanism comprises at least one wedge-shaped rib on the ejector adapted for engagement with the hollow coring bit during movement of the ejector from the retracted position to the extended position. The at least one wedge is configured to resist movement of the ejector from the extended position toward the retracted position.

In another aspect, a coring probe for collecting a frozen aliquot from a frozen biological sample generally comprises a hollow coring bit for taking a frozen sample core from a frozen biological sample. A coupling is disposed on the hollow coring bit and configured to connect the hollow coring bit to a system for driving the coring bit into the frozen sample. The coupling includes a body having an opening extending therethrough and a circumferential groove extending around an outer surface of the coupling.

In another aspect, a single-use coring probe for collecting a frozen aliquot from a frozen biological sample generally comprises a hollow coring bit for taking a frozen sample core from the frozen biological sample. An ejector is adapted to eject the frozen sample core taken by the hollow coring bit from the hollow coring bit. The ejector is movable from a retracted position to an extended position and operable to push a frozen sample core out of the coring bit as it moves from the retracted position to the extended position. A locking mechanism is adapted to discourage re-use of the single-use coring probe. The locking mechanism is adapted to resist movement of the ejector from the extended position to the retracted position. The ejector is adapted to permit electromagnetic radiation of a targeting system adapted to display an image on the frozen biological sample to pass through the ejector.

In another aspect, a coring probe for collecting a frozen aliquot from a frozen biological sample generally comprises a hollow coring bit for taking a frozen sample core from the frozen biological sample. A coupling is disposed on the hollow coring bit and configured to connect the hollow coring bit to a system for driving the coring bit into the frozen biological sample. The coupling is adapted to limit transfer of heat between the coring bit and the system.

Other objects and features will be in part apparent and in part pointed out hereinafter.

### BRIEF DESCRIPTION OF THE DRAWINGS

FIG. 1 is a side elevation of one embodiment of a system for extracting frozen sample cores from frozen samples;

FIG. 2 is a perspective of a portion of the system illustrated in FIG. 1 with portions broken away to show hidden structure;

FIG. 3 is a perspective of a cross section of the portion of the system as illustrated in FIG. 2;

FIG. 4 is a side elevation of a portion of the system illustrating one embodiment of a coring probe retaining system thereof in a retaining position;

FIG. 5 is a side elevation of the portion of the system illustrating the retaining system is a non-retaining position;

FIG. 6 is a fragmentary cross section of the retaining system showing one embodiment of a coring probe being inserted into a coring bit mount of the coring probe retaining system;

FIG. 7 is a fragmentary cross section similar to FIG. 6 showing the coring probe being inserted farther into the retaining system;

FIG. 8 is a fragmentary cross section similar to FIGS. 6 and 7 showing the retaining system retaining the coring probe therein;

FIG. 9 is a front elevation of the coring probe from FIGS. 6-8;

FIG. 10 is a perspective of the coring probe showing one embodiment of an ejector of the coring probe in a retracted position;

FIG. 10A is a perspective of the coring probe showing another embodiment of an ejector of the coring probe in a retracted position;

FIG. 11 is a perspective of the coring probe from FIG. 10 showing the ejector in an extended position;

FIG. 12 is a fragmentary cross section showing a portion of the system of FIGS. 1 and 2 showing one embodiment of a carriage at a relatively lower position;

FIG. 13 is an enlarged view of a portion of the system showing the position of one embodiment of a plunger relative to a coring probe when the carriage is at the lower position as illustrated in FIG. 12;

FIG. 14 is a fragmentary cross section similar to FIG. 12 showing the carriage at an intermediate position higher than the position shown in FIG. 12;

FIG. 15 is an enlarged view of a portion of the system similar to FIG. 13, showing the position of the plunger relative to the coring probe when the carriage is at the intermediate position illustrated in FIG. 14;

FIG. 16 is a fragmentary cross section of the system similar to FIGS. 12 and 14 showing the carriage of the system at a position higher than the intermediate position shown in FIG. 14;

FIG. 17 is an enlarged view of a portion of the system similar to FIGS. 13 and 15, showing the position of the plunger relative to the coring probe when the carriage is at the relatively higher position illustrated in FIG. 16;

FIG. 18 is a side elevation of the system of FIG. 1 showing one embodiment of a targeting system adapted to produce a display on a frozen sample directing electromagnetic radiation onto a frozen sample;

FIG. 19 is a schematic of a frozen sample having a display produced thereon, including several enlargements of various alternative embodiments of a display;

FIG. 20 is a schematic front elevation of one embodiment of a targeting system including a pair of line generators for producing a crosshair display on a frozen sample;

FIG. 21 is a schematic side elevation of the targeting system of FIG. 20;

FIG. 22 is a schematic of a frozen sample having a crosshair display produced thereon by the targeting system of FIGS. 20 and 21;

FIG. 23 is a perspective of one embodiment of a mounting block; and

FIG. 24 is a perspective the mounting block of FIG. 23 supporting a laser and plunger.

Corresponding reference characters indicate corresponding parts throughout the drawings.

### DETAILED DESCRIPTION

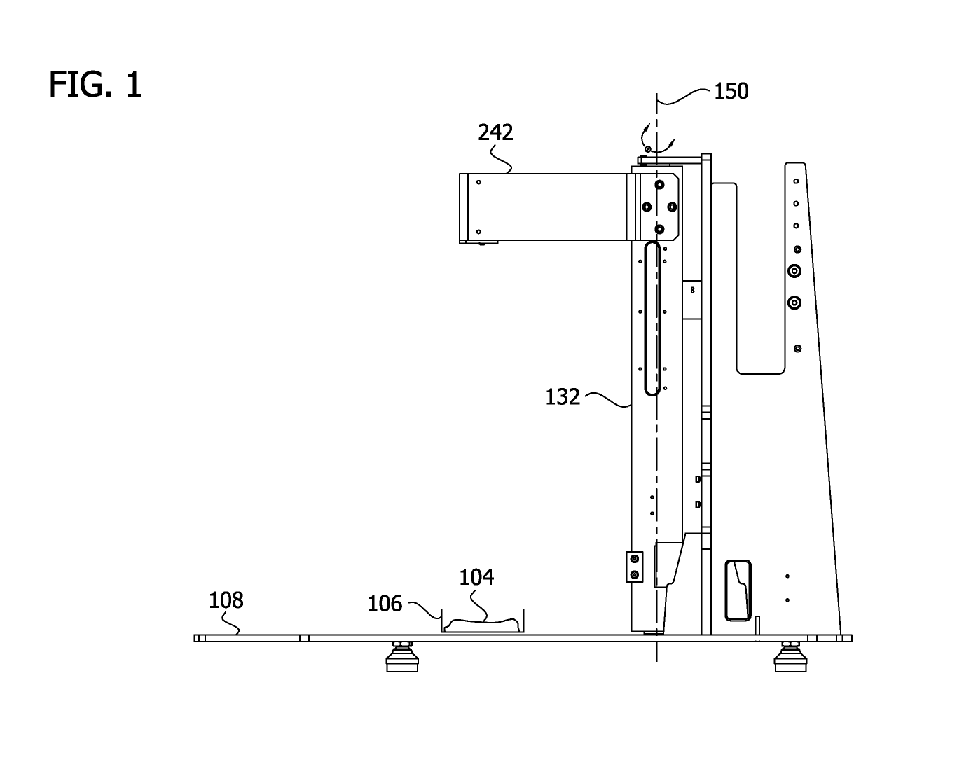

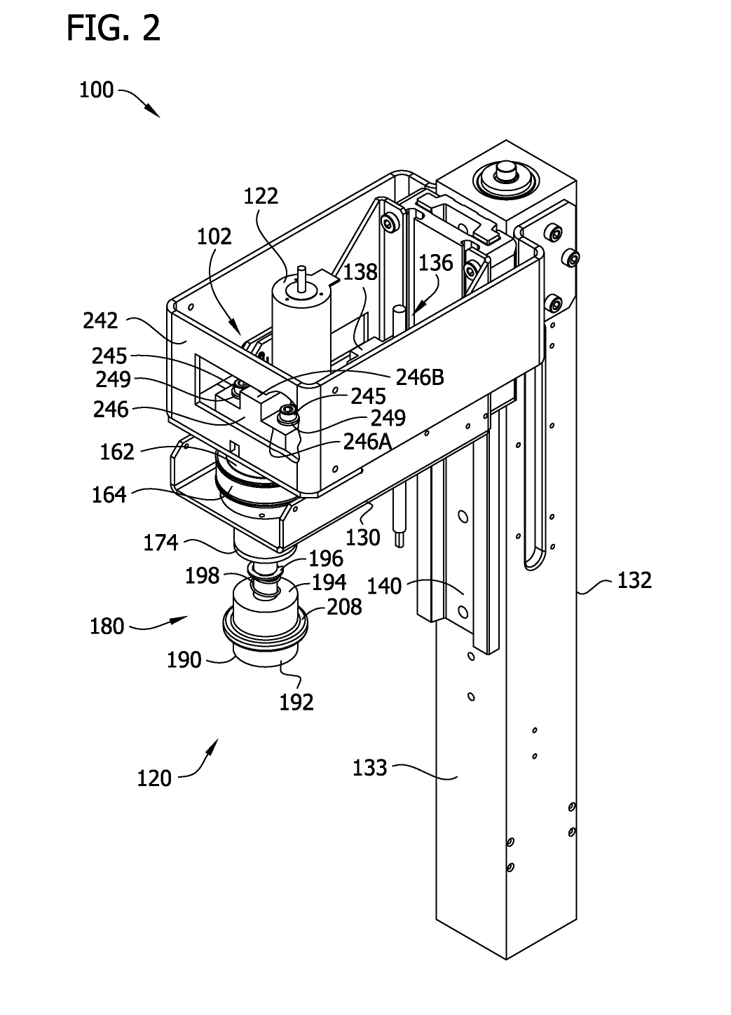

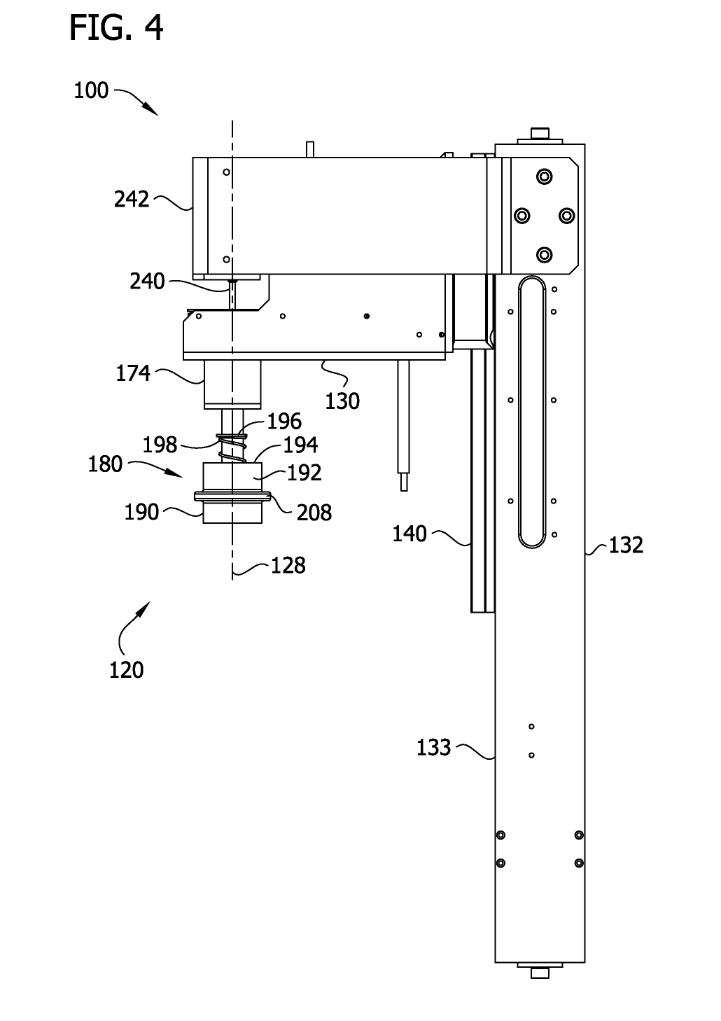

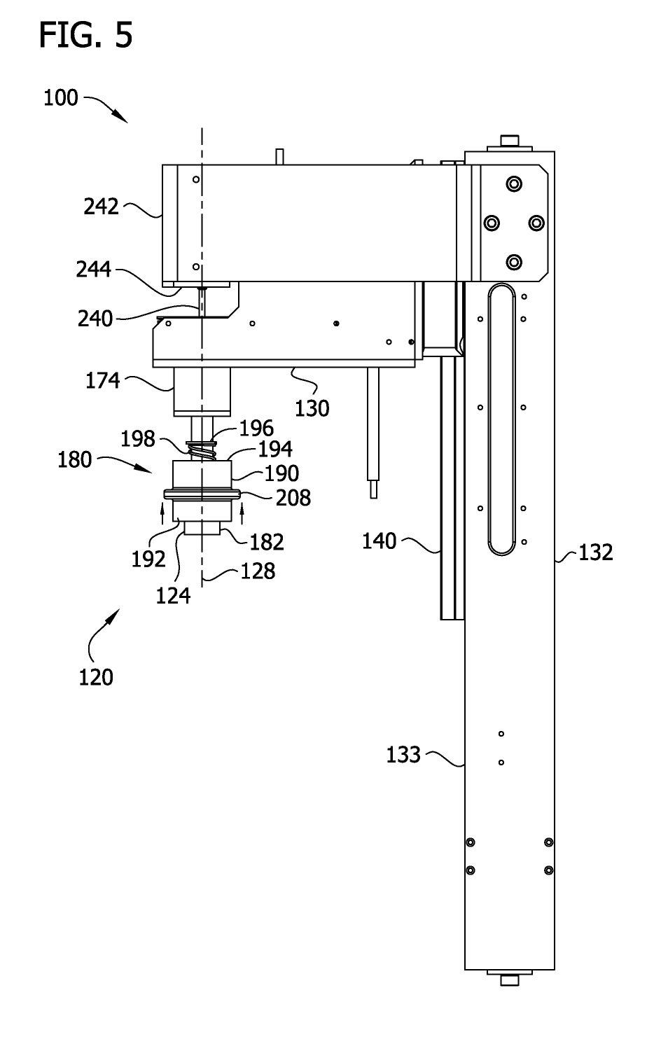

A system for extracting frozen sample cores from frozen samples, generally designated 100, is illustrated in FIGS. 2-5. The system 100 includes a targeting system 102 adapted to produce a display on a frozen biological sample 104, such as a frozen sample contained in a container 106 as illustrated in FIG. 1. The frozen sample 104 can be a frozen fluid sample and/or a frozen tissue sample, such as a formalin fixed frozen tissue sample, which may be embedded in paraffin or OCT, or a fresh frozen tissue sample. The system 100 is adapted to support a coring probe 110 including a coring bit 112 for taking a frozen sample core from the frozen sample 104. The targeting system 102 produces a display on the frozen sample 104 indicating where the coring bit 112 will contact the frozen sample to take a frozen sample core, thereby assisting a user in positioning the sample at a position that is suitable for using the system 100 to take a frozen sample core from a desired location within the sample.

The system 100 includes a coring bit mount 120 adapted to hold the coring bit 112. The coring bit mount 120 holds the coring bit 112 so the coring bit extends along a coring bit axis 278. The coring bit mount 120 is drivingly connected to a cutting action motor 122 that drives a cutting action of the coring bit 112, as described below. The coring bit mount 120 has an end 124 adapted for releasable connection to the coring bit 112 so the coring bit can be held by the coring bit mount. An opening 126 extends through the coring bit mount 120. For example, the opening 126 suitably extends along a central axis 128 of the coring bit mount 120.

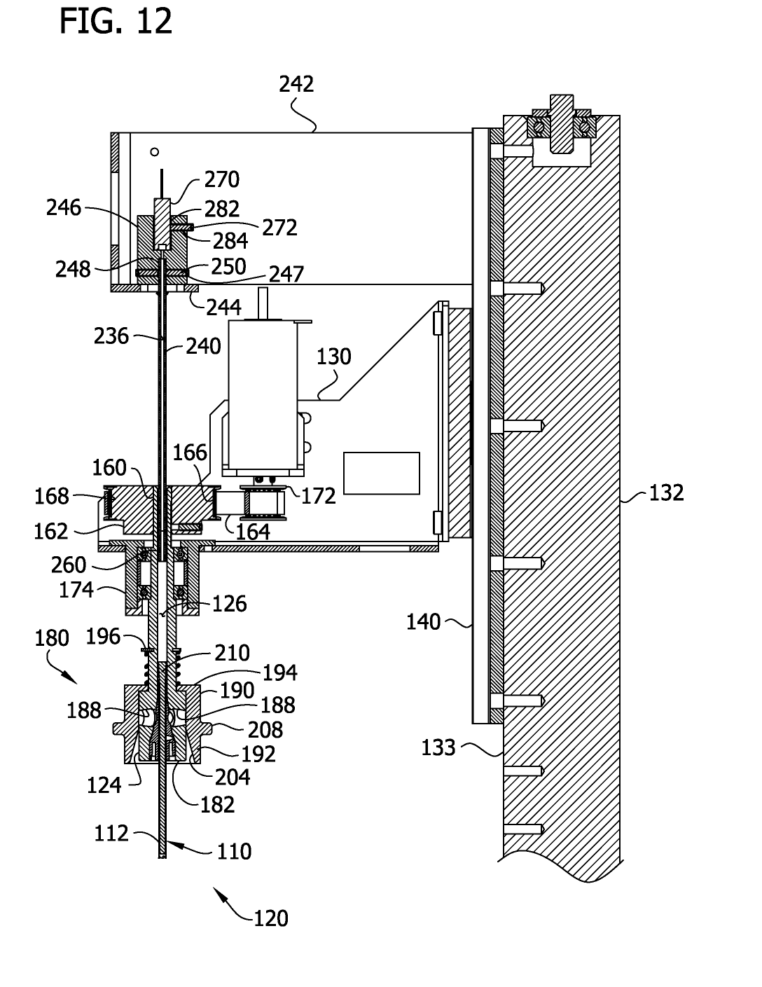

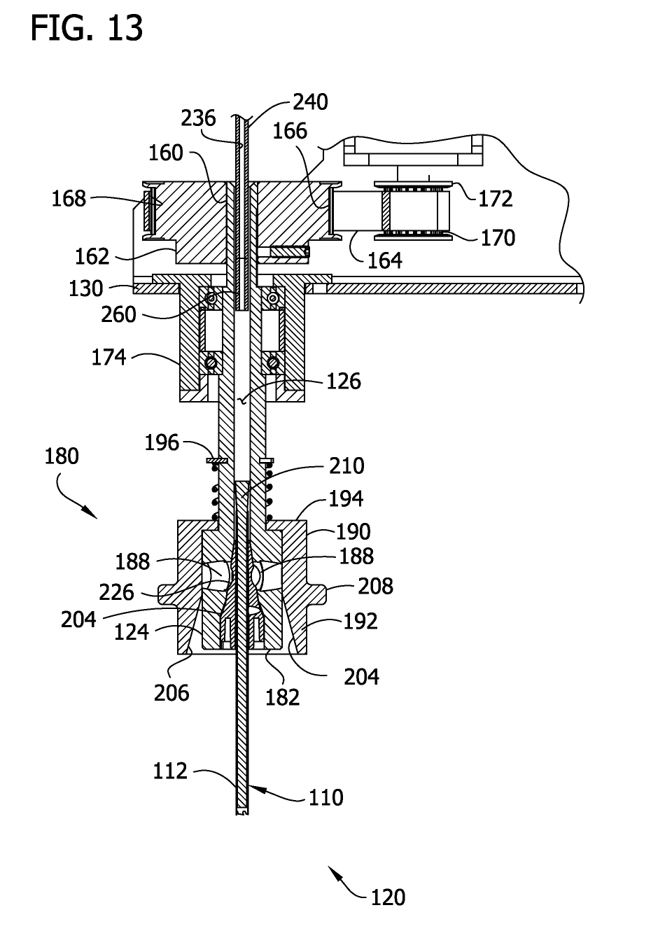

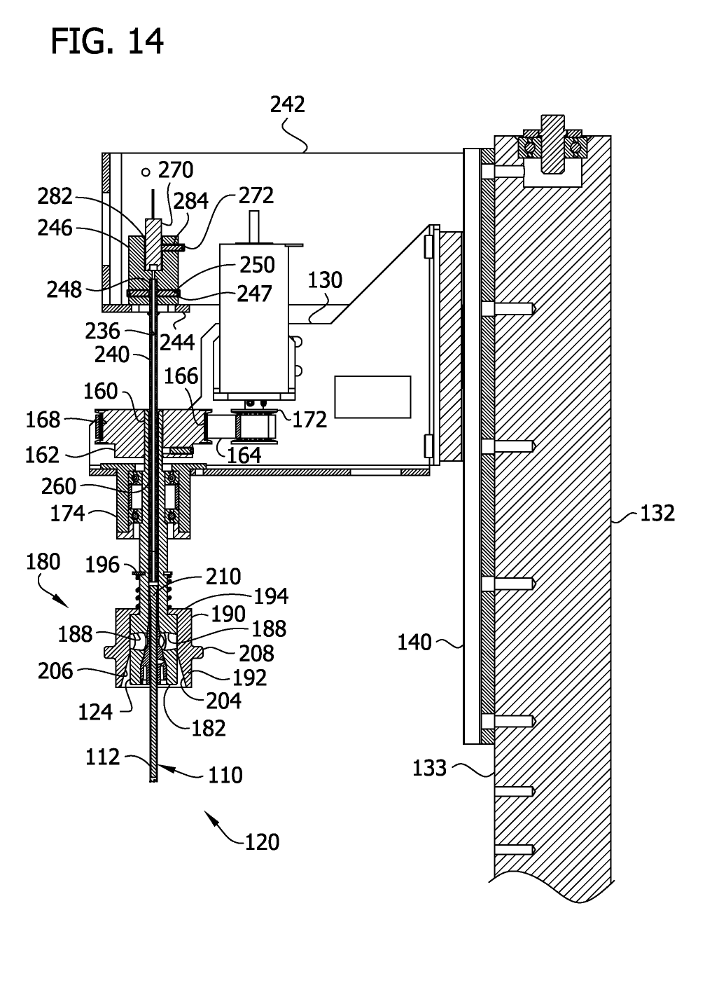

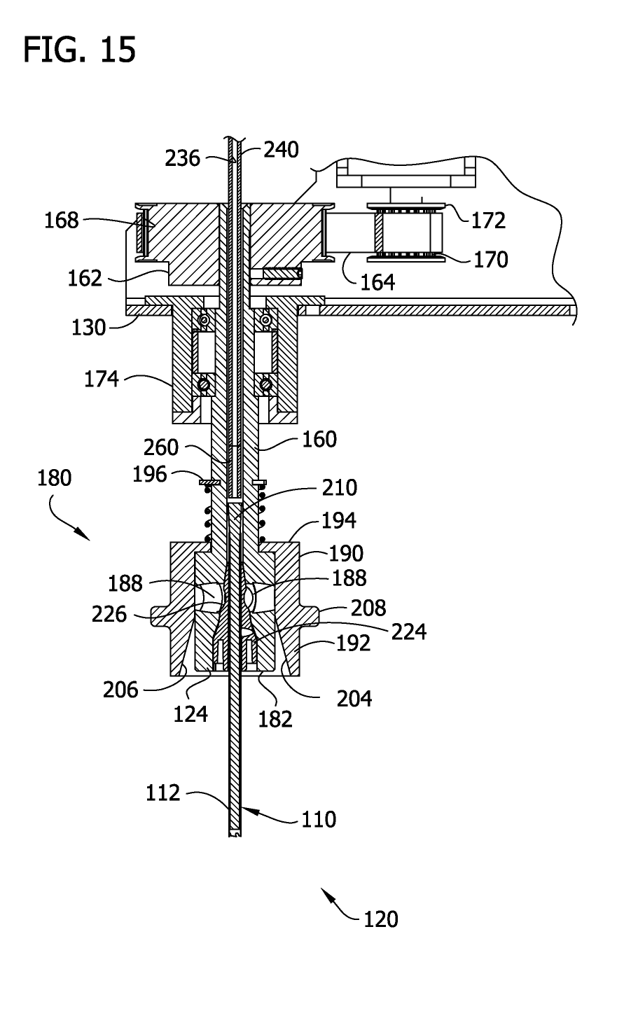

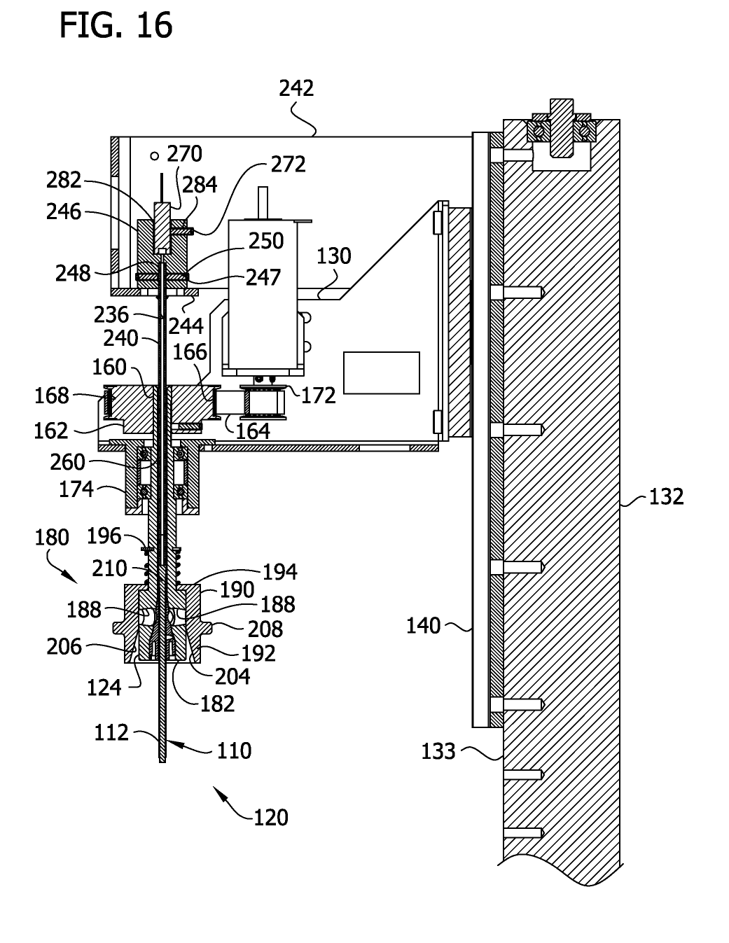

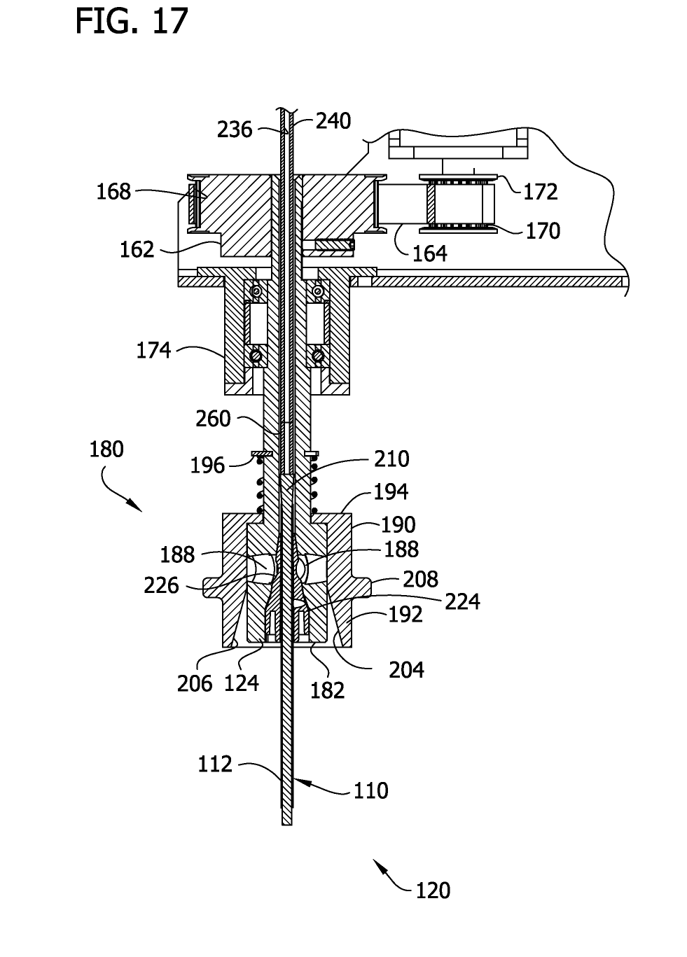

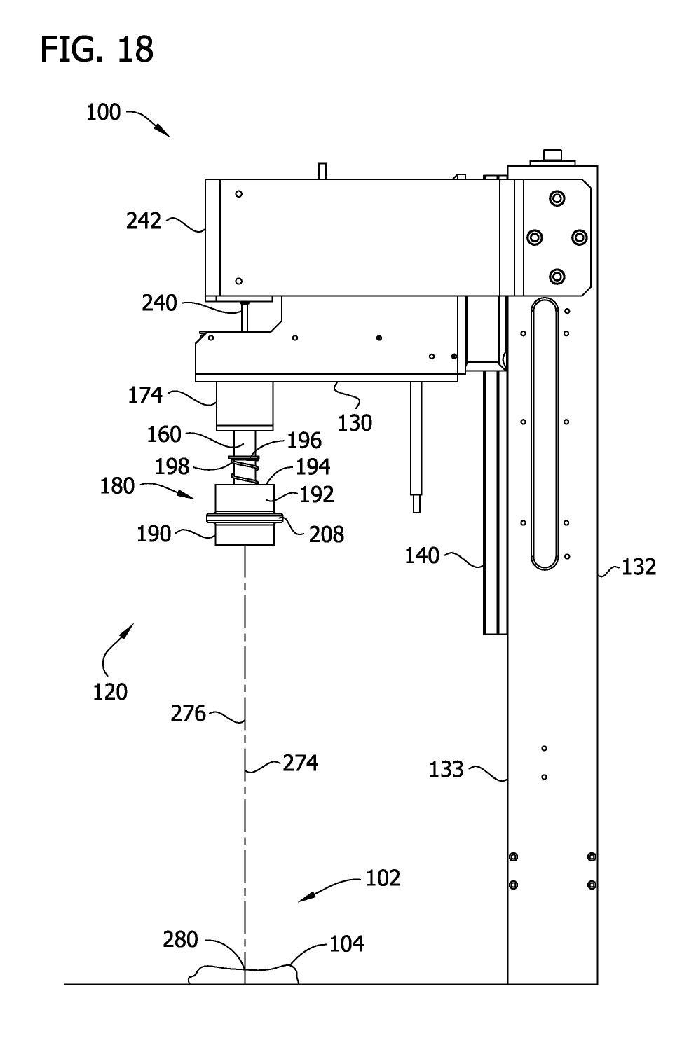

The coring bit mount 120, and therefore the coring bit 112, is movable relative to the frozen sample container 106 containing the frozen sample 104. Suitably, the coring bit mount 120 is supported by a carriage 130 that is movable relative to the frozen sample 104. In the illustrated embodiment, the carriage 130 is mounted on a support 132 (e.g., a substantially vertical upright) and is movable relative to the support and the frozen sample 104 by a drive system 136. Suitably, the drive system 136 includes a motor 138, such as a servo motor for precise positioning and movement of the carriage 130. As illustrated in FIGS. 12-18, the carriage 130 is movable along a track 140 on the support 132. The support 132 extends upward from a work area (e.g., a platform) for supporting the sample 104 during the coring process. The support 132 is suitably rotatable about a vertical axis 150 as indicated by arrows θ. The drive system 136 is adapted to move the carriage 130 along the track 140 on the support 130 toward and away from the frozen sample 104.

The drive system 136 suitably includes a processor (not shown) configured to control the motor 138. The drive system 136 is suitably configured to receive one or more inputs from a person operating the system 100. For example, the drive system 136 can include a manually-operable actuator or input device (e.g., a button (not shown)) operable by a user to initiate the coring process and produce the relative movement between the carriage 130 and the frozen sample 104. The processor is suitably configured so upon initiation of the coring process, the drive system 136 is operated to move the carriage 130 along the track 140 to insert the coring bit 112 into the sample 104 (e.g., to a pre-determined depth) and operate the motor 122 to drive the cutting action of the coring bit as it is inserted into the sample and then operate the drive system to withdraw the coring bit from the sample. Alternatively, the drive system 136 can be part of a fully-programmable robotic positioning system (e.g., (θ, Z), (θ, r, Z), (x, y, z) Cartesian, etc.) operable to produce the relative movement between the carriage 130 and the frozen sample 104. Other systems and configurations permitting relative movement between the coring bit 112 and the frozen sample 104 are within the scope of the present invention.

The cutting action motor 122 in the illustrated embodiment is drivingly connected to the coring bit mount 120 for driving a cutting action of the coring bit 112 when it is held in the coring bit mount. In the illustrated embodiment, for example, the cutting action motor 122 is suitably adapted to rotate the coring bit 112 as the coring bit is inserted into the frozen sample 104 to take a frozen sample core. Although the cutting action motor 122 in the illustrated embodiment is adapted to drive rotation of the coring bit 112, it is understood that other types of cutting actions are within the scope of the invention. For example, the cutting action motor can be adapted to produce a linear oscillatory cutting action of the coring bit, for example as described in U.S. patent Ser. No. 12/087,695, filed Jan. 17, 2007, published as U.S. 20090019877 A1.

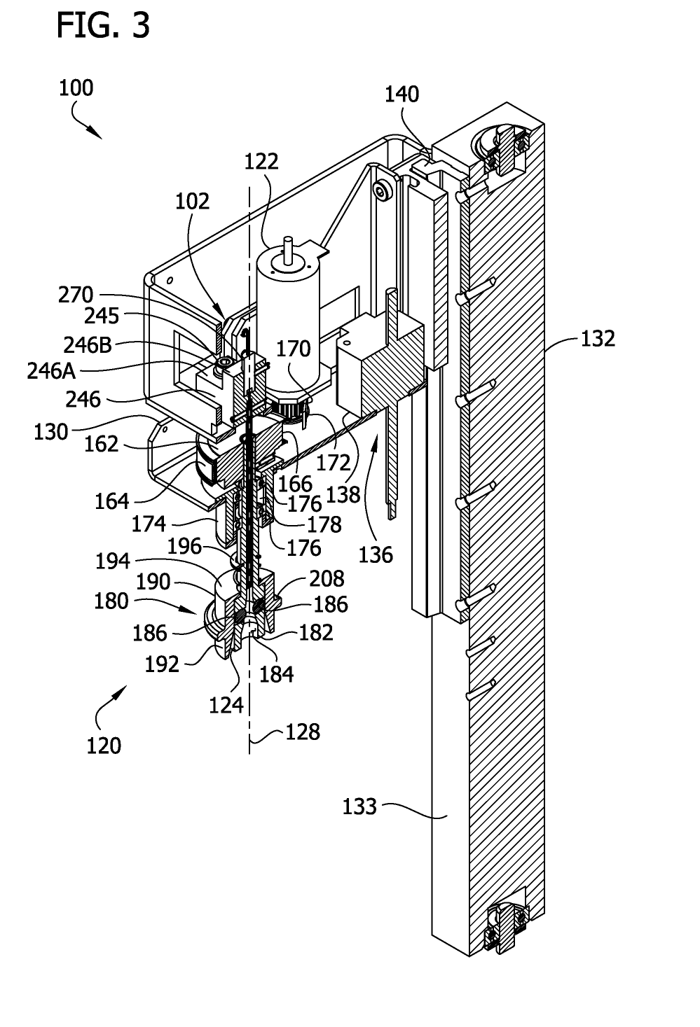

As illustrated in FIG. 3, the cutting action motor 122 is supported by the carriage 130 and movable conjointly with the carriage and the coring bit mount 120. A bearing housing 174 is mounted on the carriage 130 and surrounds a portion of the coring bit mount 120. The bearing housing 174 houses a pair of bearings 176 and a spacer 178 positioned between the bearings so it maintains a minimum spacing between the bearings. The coring bit mount 120 includes a spindle 160 that extends through the bearing housing 174 and is mounted on the carriage 130 by the bearings 176 for rotation relative to the carriage.

The cutting action motor 122 is adapted to rotate the spindle 160 to produce a rotary cutting action of the coring bit 112. The spindle 160 is connected to the cutting action motor 122 by any suitable transmission system for transmitting output from the cutting action motor to the coring bit mount. In the illustrated embodiment, for example, the spindle 160 includes a pulley 162 connected to the motor 122 by a timing belt 164. The pulley 162 and timing belt 164 include teeth 166 and notches 168, respectively, that engage with one another to limit (and preferably substantially eliminate) slippage between the belt and the pulley. Similar teeth 170 are suitably on a pulley 172 on the output shaft of the motor 122 to limit (and preferably substantially eliminate) slippage between the timing belt and the motor pulley. The cutting action motor 122 is suitably a variable speed drive motor that permits the speed at which the coring bit 112 is rotated to be selectively adjusted according to the desired operating parameters for the particular frozen biological sample being aliquotted. For example, the cutting action motor 122 is suitably controlled by the processor which can be configured to operate the cutting action motor in a specified manner (which may vary depending on various factors, including characteristics of the sample and the objectives to be achieved to name a few). Because it limits slippage, the timing belt 164 ensures that motion of the coring bit 112 closely corresponds to the specified manner in which the cutting action motor is operated.

The system 100 includes a coring probe retaining system 180 for retaining the coring probe 110. Various different retaining systems can be used within the scope of the invention. In general, the retaining system allows the coring bit 112 to be releasably connected to the coring bit mount 120. Those skilled in the art will be familiar with various chucks, collets, threaded connections, and the like that are suitable for releasably retaining a coring bit in the coring bit mount. In the illustrated embodiment, the retaining system 180 is adapted for conversion between a retaining configuration and a non-retaining configuration by movement of only a single component in substantially only one of the six possible degrees of freedom (i.e., three rotational axes and three translational axes). For example, in the illustrated embodiment the retaining system can be converted between the retaining and non-retaining configuration by moving a component linearly, as will be described in more detail below. The ability to quickly and easily convert the retaining system 180 between the retaining and non-retaining configurations using a single, simple movement allows a person operating the system 100 to quickly connect and disconnect coring bits 112 from the coring bit mount 120.

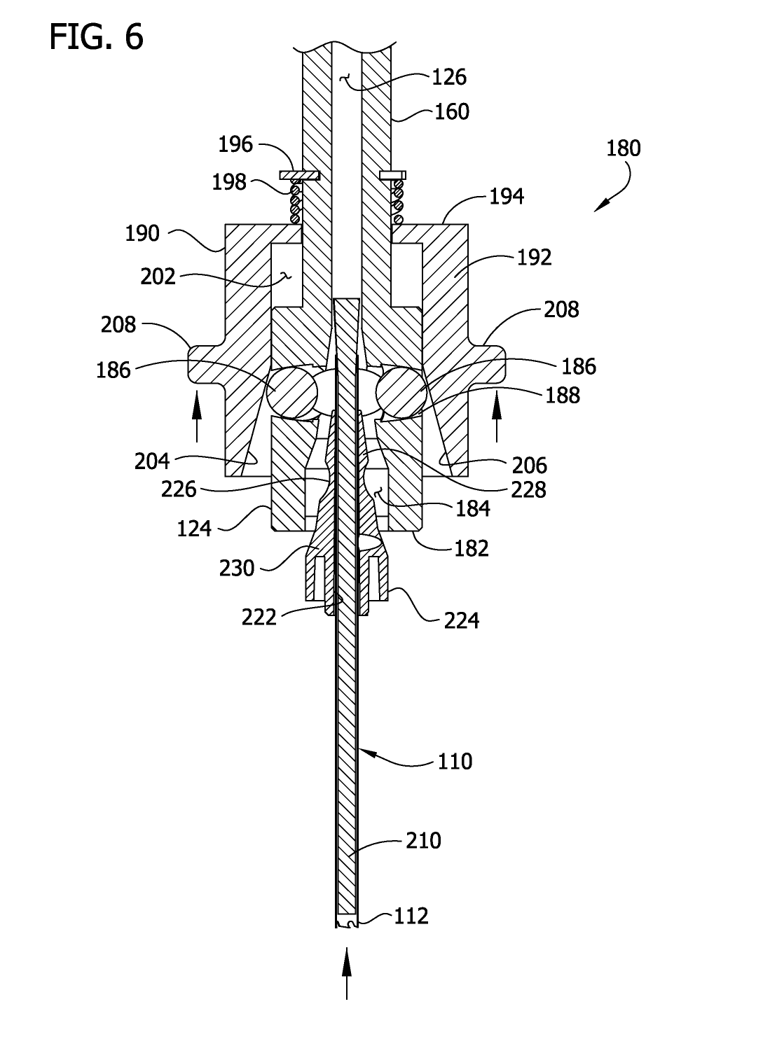

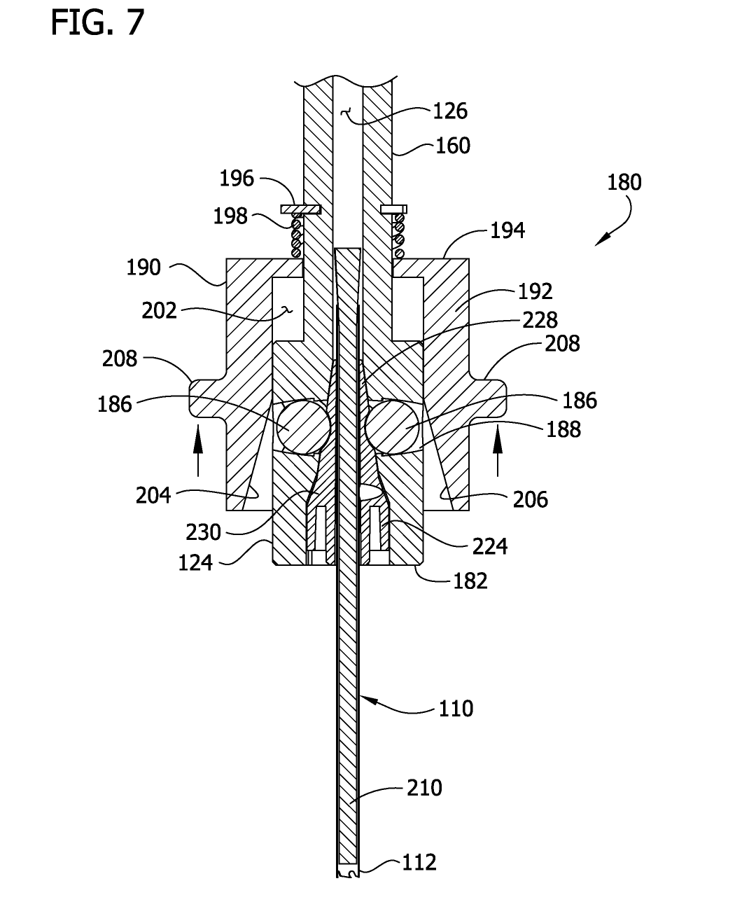

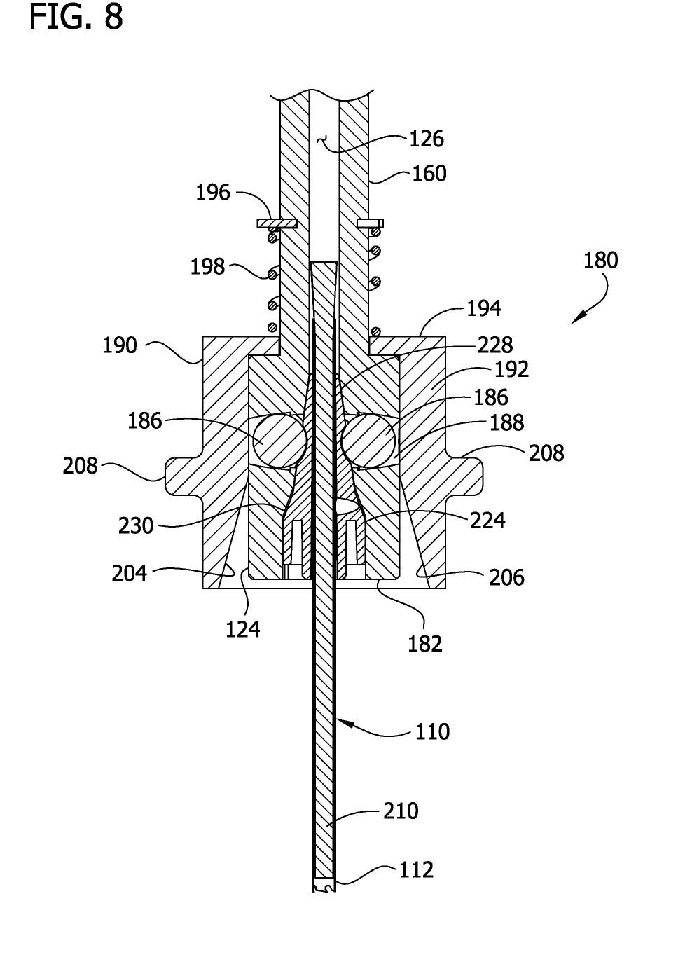

Referring to FIGS. 6-8, the end 182 of the spindle 160 of the coring bit mount 120 includes a receptacle 184 and a plurality of retainers 186 (e.g., balls) supported in radially-extending tracks 188. The balls 186 are movable between a retaining position, in which the balls are positioned at an inner end of their respective tracks 188 (see, e.g., FIG. 8), and a non-retaining position, in which the balls are positioned at an outer end of the tracks (see, e.g., FIGS. 6 and 7). The balls 186 are prevented from exiting the tracks 188 at the outer end of the tracks by a cam 190. The balls 186 are prevented from exiting the tracks 188 at the inner end of the tracks by a stop, such as a lip (not shown) at the inner end of the tracks.

The cam 190 in the illustrated embodiment surrounds a portion of the coring bit mount 120. In particular, the cam 190 is configured to surround the end 182 of the spindle 160. For example, the cam 190 suitably has a circumferential sidewall 192 extending down from an upper end 194 of the cam. The cam 190 is suitably mounted on the spindle 160 between the end 182 of the spindle and the bearing housing 174 for sliding movement relative to the spindle between a retaining position and a non-retaining position. For example, in the illustrated embodiment the spindle 160 extends through an opening in the upper end 194 of the cam 190. The cam 190 is slideable vertically on the spindle 160 between a retaining position at the lower end of the cam's sliding path and a non-retaining position at the upper end of the cam's sliding path. The spindle 160 has a stop 196 positioned above the cam 190 to limit upward movement of the cam 190 along the spindle. In the illustrated embodiment, the stop 196 is a washer that is received in a groove on the spindle 160. A biasing member 198 is positioned to bias the cam 190 toward its lower position. In the illustrated embodiment, the biasing member 198 is a helical spring compressed between the upper end 194 of the cam 190 and the stop 196. The spring 198 biases the cam 190 toward the retaining position. Additionally or alternatively, a stop or spacer can be positioned below the cam 190 to limit downward movement of the cam along the spindle, and/or the stop 196 can be removed and the biasing member 198 can be compressed between the upper end 194 of the cam 190 and the bearings 176. This configuration helps hold the bearings 176 against the spacer 178 in the bearing housing 174.

The cam 190 includes an annular space 202 for receiving the end 182 of the spindle 160. The annular space 202 and the end 182 of the spindle 160 are suitably configured for close-fitting reception of the end in the annular space. The annular space 202 and the end 182 can be generally cylindrical, as illustrated for example. The cam 190 includes a camming surface 204. In the illustrated embodiment the camming surface 204 includes a tapered surface 206. The tapered surface 206 is suitably positioned at the distal end of the cam 190. The tapered surface 206 extends from a narrower end adjacent the annular space 202 at the upper end of the cam 190 to a wider end at the lower end of the cam. The tapered portion of the camming surface 206 is positioned to contact the balls 186 and define the maximum extent to which the balls can be positioned radially outward in their tracks 188.

When the cam 190 is in its retaining position, the tapered camming surface 206 holds the balls 186 in retaining positions at the inner ends of their tracks 188. When the balls 186 are in their retaining positions, there is a relatively smaller amount of space between the balls for retaining the coring bit 112 in the spindle 160. The cam 190 can be moved upward against the bias of the spring 198 by a user toward the non-retaining position. As the cam 109 is moved toward its non-retaining position, the tapered portion of the camming surface allows the balls 186 to move farther toward non-retaining position at the radially outward ends of their tracks 188. When the balls 186 are in their non-retaining positions, there is a relatively larger space between the balls for releasing the coring bit 112 from the spindle 160. When the cam 190 has been moved upwardly sufficiently to allow enough separation between the balls 186 to release the coring bit 112, the cam has reached its non-retaining position.

The cam 190 suitably includes a grip 208 to facilitate manual movement of the cam toward its non-retaining position by a person operating the system 100. In the illustrated embodiment, for example, the grip 208 includes a flange extending radially outward from the outer surface of the cam sidewall 192 at a position above the lower end of the cam 190. Thus, a user can hold the cam sidewall 192 below the flange 208 and push up against the flange to move the cam 190 upward toward the bearing housing 174 against the bias of the spring 198 to release the coring bit 112 from the spindle 160.

The receptacle 184 in the end 182 of the spindle 160 is tapered from a narrower proximal end to a wider distal end. The coring probe 110 is received in the receptacle 184 in the end 182 of the coring bit mount 120. The coring probe 110 includes the hollow coring bit 112 (e.g., hollow tube having a cutting tip) for taking a frozen sample core from the frozen sample and an ejector 210 adapted to eject the frozen sample core contained in the coring bit 112 from the end of the coring bit. The ejector 210 is movable from a retracted position to an extended position and operable to push any frozen sample core retained in the coring probe 112 out of the coring probe as it moves from the retracted position to the extended position. For example, the distal end of the ejector 210 suitably moves from a position within the hollow coring bit 112 and spaced from a distal end of the coring bit to a position beyond the distal end of the coring bit as the ejector moves to the extended position.

The coring probe 110 is suitably configured for only a single use. Detailed information about single-use coring probes is provided in commonly-owned U.S. Application No. 61/675,016, filed Jul. 24, 2012, U.S. Application No. 61/784,753, filed Mar. 14, 2013, and U.S. application Ser. No. 13/950,170, filed Jul. 24, 2013, all of which are entitled Apparatus and Methods for Aliquotting Frozen Samples, the contents of which are incorporated herein by reference. Use of a single-use coring probe prevents the risk of cross-contamination of samples (e.g., due to improper cleaning of the probe between samples) and eliminates the need for a cleaning process.

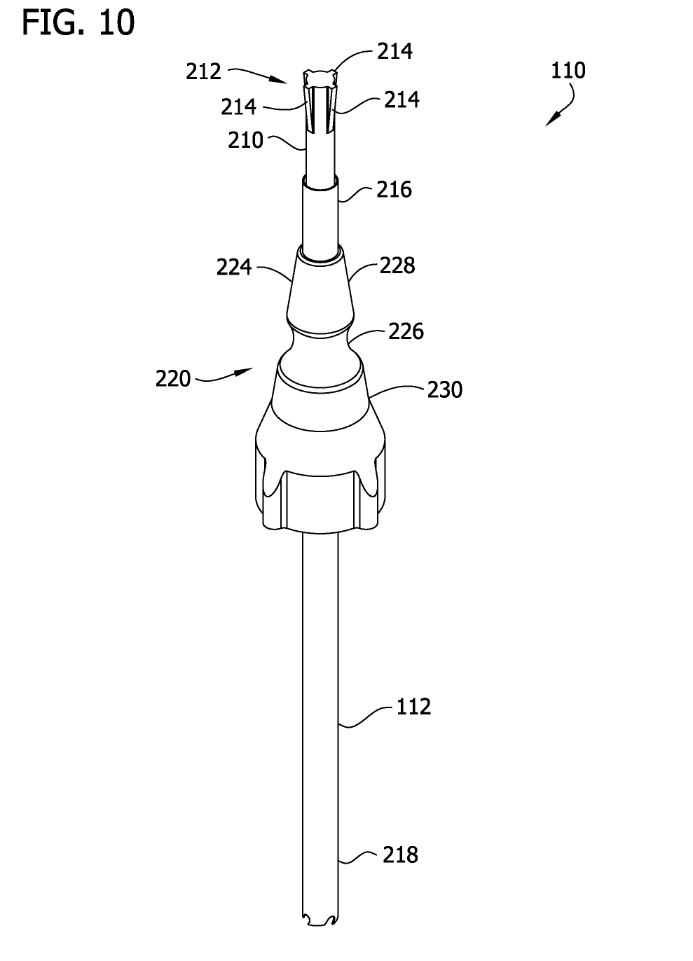

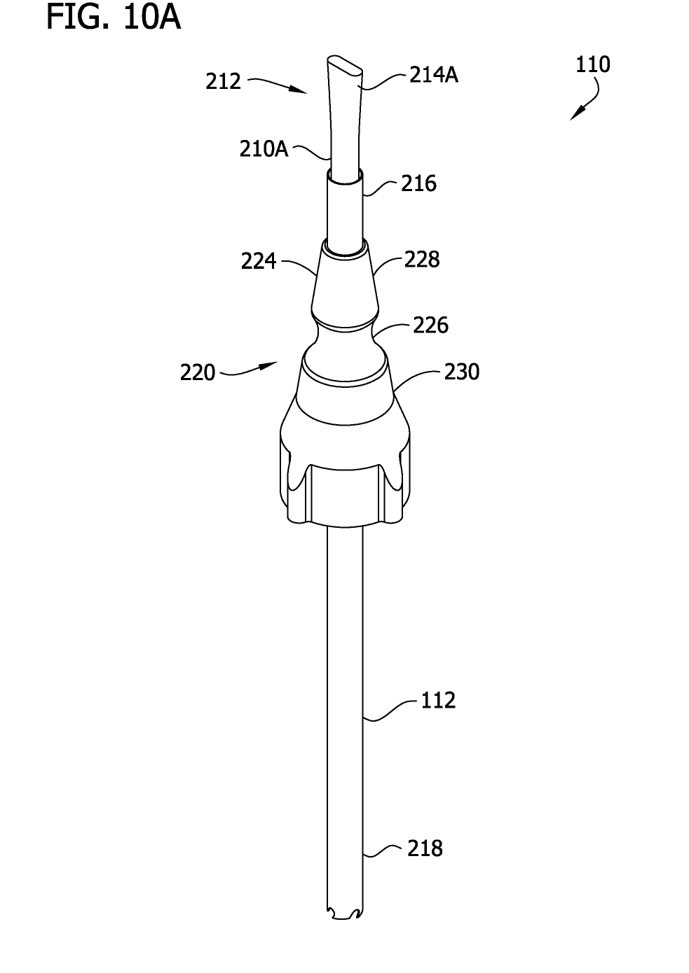

Use of a single-use coring probe to obtain a frozen sample core suitably converts the coring bit 112 to a state in which the coring bit is not suitable for use obtaining another frozen sample core. For example, the coring probe 110 suitably includes a locking mechanism 212 adapted to discourage re-use of the coring probe to ensure that the coring probe is used only once, thereby preventing the possibility for carryover or contamination between samples. As seen in FIG. 10, the locking mechanism 212 comprises a plurality of wedge-shaped ribs 214 extending radially from the exterior surface of the ejector 210. In the illustrated embodiment, the locking mechanism 212 includes a plurality of wedge-shaped ribs 214 (e.g., four ribs). The ribs 214 are adapted for engagement with the hollow coring bit 112 during movement of the ejector from the retracted position to the extended position. The ribs 214 are positioned on a portion of the ejector that extends above the proximal end 216 of the coring bit 112 when the ejector is in the retracted position. The ribs 214 in the illustrated embodiment are not in contact with the coring bit 112 when the ejector 210 is in the retracted position. When the ejector 210 is moved from the retracted position to the extended position to eject the frozen aliquot, the ribs 214 are inserted into the proximal end of the coring bit 112. The ribs 214 are configured to stick in the proximal end 216 of the coring bit 112 and resist movement of the ejector back from the extended position back toward the retracted position. For example, the ribs 214 are suitably sized and shaped so the ribs must be jammed into the proximal end of the coring bit (e.g., deforming at least one of the ribs and the proximal end 216 of the coring bit) so that the portion of the ejector 210 having the ribs cannot easily be extracted from the coring bit. Thus, use of the ejector 210 to eject a frozen sample core from the coring bit results in automatic locking of the ejector in the extended position, which prevents or at least provides a substantial deterrent against use of the same coring probe 110 to obtain a frozen sample core from any additional frozen samples. Although, the coring probe 110 in the illustrated embodiment is a single-use coring probe, it is understood that the coring probe can be a reusable coring probe within the scope of the present invention. Moreover, various other single-use coring probes different from the coring probe 110 in the illustrated embodiment can be used without departing from the scope of the invention. For example, FIG. 10A shows an ejector 210A having an oblong proximal end such that wedges 214A are formed on opposite sides of the ejector.

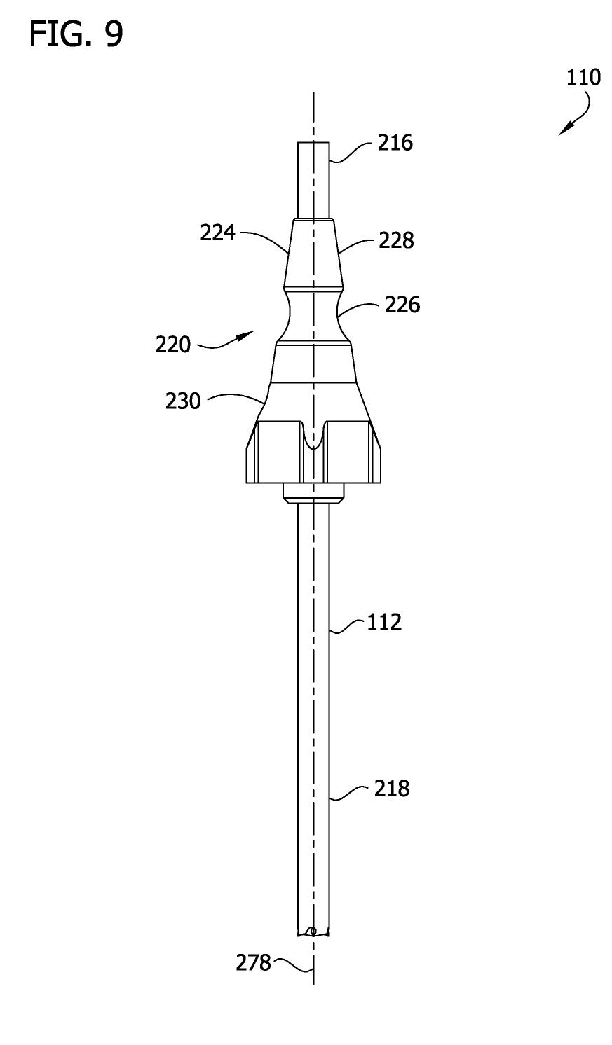

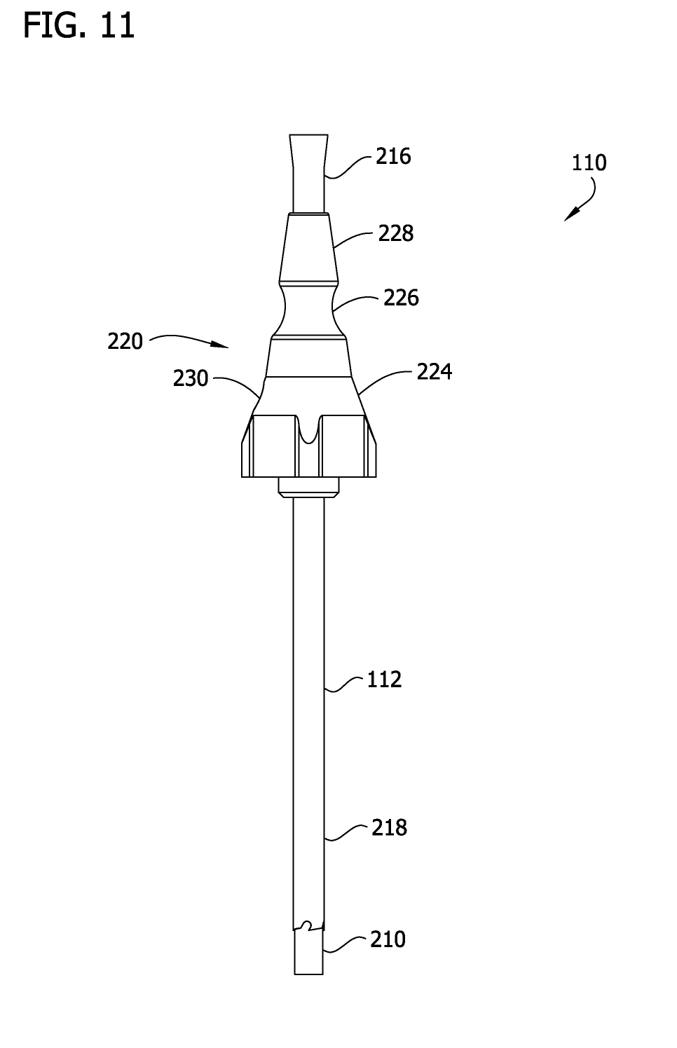

Referring to FIGS. 9-11, the coring probe 110 includes a coupling 220 adapted to connect the probe and the coring bit 112 thereof to a system for driving the coring bit into the frozen sample 104. Suitably, for example, the coupling 220 is adapted to connect the coring bit 112 to the coring bit mount 120. In the illustrated embodiment, the coupling 220 is secured to the outer surface of the coring bit 112 between its proximal and distal ends 216, 218. For example, the coupling 220 suitably has a central opening 222 (e.g., bore) that receives the coring bit 112 (e.g., via an interference fit that securely holds the coring bit in the coupling). In the illustrated embodiment, the hollow coring bit 112 extends completely through the coupling 220 from one end of the coupling to its opposite end. The coupling 220 can be adhered to the coring bit 112 (e.g., using glue or other adhesives), overmolded onto the coring bit, and/or may include one or more projections extending into an opening in the side of the coring bit to secure the coupling to the coring bit. The coupling 220 is sized and shaped to be received in the receptacle 184 at the end 182 of the spindle 160 of the coring bit mount 120. The coupling 220 and the receptacle 184 are each suitably symmetrical about their central axes to facilitate connecting the coupling to the coring bit mount 120 without any concern about the rotational orientation of the coring probe 110 on its axis relative to the orientation of the coring bit mount 120.

Referring to FIGS. 9-11, the coupling 220 has a body 224. In the illustrated embodiment, the body includes a tapered portion. For example, the entire body 224 is suitably generally tapered. The tapered body 224 has a narrower proximal end and a wider distal end. The tapered body 224 is sized and shaped for close-fitting reception in the receptacle 184 at the end of the spindle 160. A circumferential groove 226 (FIG. 6) extends radially into the body 224 around an outer surface of the body and separates the body into an upper portion 228 and a lower portion 230. The groove 226 is configured to receive the balls 186 to retain the coring probe 110 in the coring bit mount 120. When the balls 186 are in the non-retaining position, the upper portion 228 of the coupling 220 can be inserted past the balls 186 into the coring bit mount 120 until the groove 226 is aligned with the balls. The tapered shape of the coupling 220 facilitates inserting the upper portion 228 of the coupling between the balls 186 by gradually moving the balls radially outward in their tracks 188 if needed. When the balls 186 are in their retaining positions they are received in the groove 226 on the coupling 220 and thereby retain the coupling in the coring bit mount 120 by resisting movement of the coring probe 110 either downward or upward relative to the spindle 160. The coupling 220 can include one or more keys (not shown) or other suitable features engageable with the coring bit mount 120 to hold the coring bit 112 in substantially fixed orientation relative to the spindle 160 to facilitate transmission of rotational movement of the spindle to the coring bit.

The coupling 220 is adapted to limit transfer of heat between the coring bit 112 and the system 100. For example, the coupling 220 is suitably made from a material having a relatively low thermal conductivity. The coring bit 112 is suitably pre-cooled before the coring operation. This pre-cooling can be accomplished in various ways, such as by keeping the coring probe 110 in a cold location until it is ready for use, exposing the coring bit 112 to a coolant (e.g., liquid nitrogen, the vapor above liquid nitrogen, dry ice, a slurry containing dry ice and alcohol or another liquid, cold gas, etc.) just before use, either by immersing the coring bit in the coolant or by exposing the coring bit to a stream including the coolant. Pre-cooling can include actively cooling an individual coring bit 112 to reduce its temperature just before use or it can include keeping a set of coring probes 110 in an environment that ensures all the coring bits 112 in the set are already at a desirably low temperature when an individual coring probe from the set is selected for use in a coring process. The pre-cooling system can be adapted to ensure the temperature of the coring bit 112 is no more than about −20 C when the coring bit first contacts the frozen sample, such as no more than about −40 C when the coring bit first contacts the frozen sample, such as more than about −60 C when the coring bit first contacts the sample, such as no more than about −80 C when the coring bit first contacts the sample. The low thermal conductivity of the coupling limits heating of the coring probe 112 by the coring bit mount 120 and the rest of the system 100, which has a substantially larger thermal mass and which would be much more difficult to maintain at such a low temperature because of the energy requirements to keep such a large thermal mass at such a low temperature and because of difficulties operating motors and other components of the system at such a low temperature. The thermal conductivity of the coupling 220 is suitably no more than about 50 w/mK, more suitably no more than about 10 w/mK, more suitably in the range of about 0.001 w/mK to about 5 w/mK, still more suitably no more than about 0.001 w/mK to about 2 w/mK. Suitable materials having a low thermal conductivity that can be used for the coupling 120 include plastics, ceramics, rigid foams (e.g., cast urethane), stainless steel, graphite, carbon fiber, metal matrix composites (e.g., steel graphite combinations) honeycomb skinned materials, etc. The coupling can include an air or vacuum-filled void space to provide additional resistance to heat transfer through the coupling. The inclusion of one or more void spaces in the coupling can allow the effective thermal conductivity to be reduced to the levels set forth above even when the coupling is made from a base material having a higher thermal conductivity. The coupling can also be made from a non-insulating material having a higher thermal conductivity within the scope of the invention.

The system 100 includes an ejection system to eject the frozen sample core from the coring bit 112. In the illustrated embodiment, for instance, the ejection system includes a plunger 240 for actuating the ejector 210 to eject a frozen sample core from the coring bit 112. As illustrated in FIG. 12, the plunger 240 is a rod attached at one end to a bracket 242 that is fixed relative to the support 132 so that movement of the carriage 130 that supports and moves the coring bit mount 120 and any coring probe 110 held therein produces movement of the plunger relative to the components of the coring bit mount 120, including the spindle 160 and the coring bit 112. The opposite end of the plunger 240 extends into the opening 126 in the coring bit mount 120. The plunger 240 is suitably hollow and has a bore 236 extending therethrough. In the illustrated embodiment, the bracket 242 supports a platform 244. A mounting block 246 is supported by the platform 244. The mounting block 246 includes a receptacle 248 configured to receive a proximal end of the plunger 240. The plunger 240 is fixed in the mounting block 246 by any suitable connector, such as by a set screw 247 extending through a bore 250, or any other suitable connection. The plunger 240 is positioned so its distal end 260 is spaced from the ejector 210 of a coring probe 110 held by the coring bit mount 120 when the carriage 130 is in a lowered position (e.g., a position in which the coring bit 112 is inserted into the sample) and so the distal end of the plunger will contact the ejector 210 and move it from its retracted position to its extended position as the carriage is raised from the lowered position to it fully raised position.

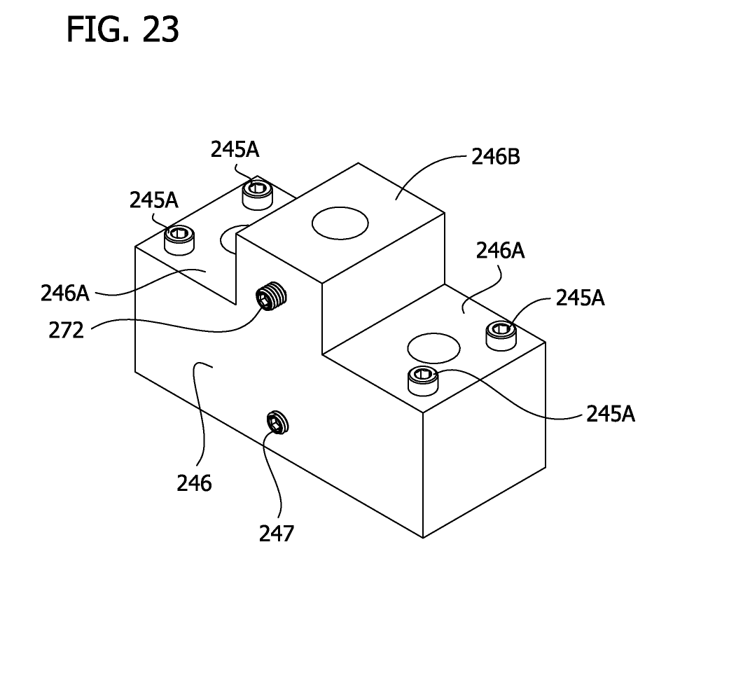

Referring to FIGS. 2 and 3, one embodiment of a mounting block 246 comprises a pair of side sections 246A and a central section 246B between the side sections. The central section 246B is raised above the side sections 246A. In the illustrated embodiment, a screw 245 extends through each side section 246A to secure the mounting block 246 to the platform 244. A washer or shim 249 is disposed between a head of each screw 245 and a top surface of a respective side section 246A of the mounting block 246 to facilitate alignment of the mounting block 246, and targeting system 102, on the platform 244. For instance, tightening the left screw 245 (as shown in FIG. 2) more than the right screw 245 will tilt the targeting system 102 counter-clockwise within a vertical plane extending generally parallel to a front surface 133 of the support 132. Similarly, tightening the right screw 245 (as shown in FIG. 2) more than the left screw 245 will tilt the targeting system 102 clockwise within a vertical plane extending generally parallel to the front surface 133 of the support 132. Thus, the screws 245 provide adjustment within a single plane. It will be understood that a relatively small amount of adjustment is achieved with the screws 245 for providing fine tune alignment of the targeting system 102. This may be desirable to ensure the targeting system is very precisely aligned with the location where the coring bit will intersect the sample. It may also be desirable, for example, to ensure the laser 270 extends through the hollow center of the plunger 240 without hitting the interior surface of the plunger. Additionally or alternatively, four screws 245A (FIG. 23) at corners of the mounting block 246 secure the mounting block to the platform 244. This configuration provides an increased degree of adjustment by allowing the mounting block 246 to be tilted about multiple different axes. For instance, each screw 245A can be individually tightened to a greater degree than the other three screws 245A and/or a first pair of screws 245A can be tightened to a greater degree than a second pair of screws 245A to tilt the mounting block 246 various different ways. Further, any number of the screws 245A can be tightened or loosened relative to the others to impart the desired fine tune adjustment of the targeting system 102.

The targeting system 102 suitably includes a light source 270 (e.g., a laser, such as a diode laser) positioned to direct electromagnetic radiation onto the sample 104 when the sample is positioned in the path of the coring bit 112. The light source 270 can be on continuously during operation of the system 100 or it can be selectively activated (e.g., using a button or switch (not shown)). In the illustrated embodiment, for example, a laser 270 is mounted on the bracket 242 at the proximal end of the plunger 240. The laser 270 is received in a receptacle 282 of the mounting block 246. The laser 270 is secured to the mounting block 246 by any suitable connector, such as by a set screw 272 extending through a bore 284, or by any other suitable connection. For instance, additionally or alternatively, the laser 270 can be secured in the receptacle 282 by friction fit. The laser 270 is positioned to direct electromagnetic radiation (e.g., a beam of visible or UV light) downward through the bore 236 of the plunger 240 and through the opening 126 in the coring bit mount 120 onto the sample 104 to create a display 280 indicating where the path of the coring bit intersects the sample. The targeting system 102 is configured to direct electromagnetic radiation along the axis 278 of the coring bit 112 to the frozen sample 104. For example, the targeting system suitably directs electromagnetic radiation through the spindle 160 and the rest of the coring mount 120 through the opening therein. When the coring probe 110 is mounted in the coring bit mount 120, it is in the path of the laser beam 274. The ejector 210 can be made of a material that allows light from the laser to pass through the coring probe 110. For example, the ejector 210 can be or include a waveguide extending through the ejector for transmitting the laser beam through the coring probe 110. For another example, the ejector may be made of a material that is transparent or translucent to the light from the laser so some of the laser light is passed through the coring probe 110. Moreover, when the coring probe 110 has not yet been mounted on the coring bit mount 120, the coring probe is not in the path of the laser beam 274 and the laser 270 directs the beam of light through the bore 236 of the plunger 240 and through the opening 126 in the coring bit mount 120 to produce the display 280 on the frozen biological sample 104 even if the coring probe 110 blocks the light when it is mounted in the coring bit mount.

The display 280 includes a pattern 290 centered on the intersection of the coring bit path 276 and the frozen biological sample 104. The pattern 290 suitably includes a dot or spot 292 that is substantially coincident with the intersection of the coring bit path 276 with the frozen biological sample 104. In the illustrated embodiment, for example, the display 280 comprises the visible spot 292 of the laser beam and/or any visible emissions (e.g., fluorescence) from the sample stimulated by the laser 270 at the intersection of the coring bit path 276 with the sample. The pattern 290 of the display may include additional features created by other light sources or features of the targeting system without departing from the scope of the invention. A person using the system 100 can observe the display 280 on the frozen biological sample 104 and adjust the position of the coring bit mount 120 and/or the frozen sample until the display indicates a desired portion of the frozen sample, from which the user wishes to obtain a frozen sample core, is positioned in the path of the coring bit 112.

According to one method of obtaining a frozen sample core using the system 100, a person selects a frozen sample 104 from which a frozen sample core is to be taken and positions the frozen sample generally under the coring bit mount 120 in the coring bit path. The frozen sample 104 can be a frozen fluid sample and/or a frozen tissue sample. The frozen sample can be contained in a container 106 or it can be placed on a platform 108 under the coring bit mount 120. The targeting system 102 is used to direct electromagnetic radiation onto the frozen sample 104 to produce a display 280 on the frozen sample to determine what portion of the sample is positioned to be cored by the system 100. The user can then confirm that the position where the coring bit path 276 intersects the frozen sample 104, as indicated by the display, is at a location on the sample from which a frozen sample core is desired. If necessary, the positions of the coring bit mount 120 and/or sample 104 are adjusted to reduce the difference between the position indicated by the display and the desired location until the display 280 produced by the targeting system 102 indicates the desired portion of the frozen sample is in the path 276 of the coring bit 112. Suitably, the frozen sample 104 is moved relative to the coring bit path 276 while the display 280 is being produced on the frozen sample. Suitably, the targeting system 102 directs electromagnetic radiation onto the frozen sample 104 while there is no coring bit 112 in the system 100.

Alternatively, the targeting system can direct electromagnetic radiation through the coring bit while it the coring bit is in the system.

Once the user has positioned the coring bit mount 120 and the frozen sample 104 so that the display 280 indicates the coring bit path 276 intersects the frozen sample at a desired sampling location, the user then attaches the coring probe 110 to the coring bit mount. For example, the user suitably grabs the cam 190 (e.g., using one hand) and moves up against the force of the spring 198 to its non-retaining position using the grip 208. While the cam 190 is in the non-retaining position, the person grips the coring probe 110 (e.g., using the other hand) and inserts the coupling 220 of the coring probe 110 into the receptacle 184 and the end 182 of the spindle. This action includes inserting the upper portion 228 of the coupling past the balls 186 of the retaining system 180 until the groove 226 is aligned with the balls. Then the user releases the cam 190 or allows the spring 198 to move the cam to the retaining position. As the cam 190 moves toward the retaining position, the tapered camming surface 204 forces the balls 186 radially inward to their retaining positions. The cam 190 holds the ball 186 in their retaining positions as long as the cam remains in its retaining position.

At this point, the coring bit mount 120 holds the coring bit 112 and the rest of the coring probe 110 between the laser 270 and the frozen sample 104 so the coring bit is held in the path of the beam of light. If the coring probe has a waveguide, is transparent or translucent, or is otherwise adapted to allow light to pass through it, the display 280 or some semblance thereof may remain visible on the sample 104. Otherwise, once the coring probe 110 is positioned in the path of the laser, the display 280 is no longer visible on the frozen sample 104. However, the sample is still in the desired position because there is no need to move the coring bit mount 120 or sample 104 to connect the coring probe 110 to the spindle 160.

After the coring probe 110 is inserted into the coring bit mount 120, the user operates an actuator (e.g., a button) to initiate the coring process. The processor operates the drive system 136 to produce relative movement between the frozen sample 104 and the carriage 130 for moving the coring bit 112 along the coring bit path 276 into the frozen biological sample. The processor also operates the cutting action motor 122 to drive the cutting action of the coring bit 112 as the drive system 136 drives the coring bit into the frozen sample 104, which results in a frozen sample core being positioned in the distal end of the coring bit 112. The processor then operates the drive system 136 to withdraw the coring bit 112 and the frozen sample core contained therein from the frozen sample 104.

When the coring is completed, the coring bit mount 120 is moved relative to a destination receptacle for receiving the frozen sample core so the coring bit is directly over the destination receptacle. Suitably, the frozen core is ejected into a cold destination container (e.g., an aliquot-receiving tube), well plate (e.g., a 96 well plate or other well plate), frozen tissue micro-array, or other structure to ensure the frozen aliquot remains frozen, thereby maintaining the biological integrity of the frozen aliquot. Once the destination receptacle is in position, the drive system 136 is operated to raise the carriage 130 until the distal end of the plunger 240 contacts the proximal end of the ejector 210. As the carriage 130 is raised farther, the plunger 240 pushes the ejector 210 into the proximal end of the coring bit 112 as the coring bit continues moving up along with the rest of the coring probe 110 while the ejector is held stationary by the plunger. Consequently, the plunger 240 moves the ejector 210 from the retracted position to the extended position and ejects the frozen sample core from the distal end of the coring bit 112.

Upon ejection of the frozen sample core and movement of the ejector 210 to the extended position, the ejector 210 remains jammed into the proximal end of the coring bit 112 making it difficult or impossible to re-use the single-use coring probe 110 to take another frozen sample core. The user then removes the coring probe 110 from the coring bit mount 120. To remove the coring probe 110 from the coring bit mount 120, the user uses the grip 208 on the cam 190 to move the cam upward against the bias of the spring 198 toward it non-retaining position. This upward movement of the cam 190 permits the balls 186 to move radially outward in their tracks 188 to their non-retaining positions. While holding the cam 190 in the non-retaining position, the user pulls the coring probe 110 down away from the coring bit mount 120. The coupling 220 on the coring probe 110 pushes the balls 186 radially outward in the tracks 188 sufficiently for the upper portion 228 of the coupling 220 to slide past the balls. Once the coring probe 110 is disconnected from the coring bit mount 120, the user can release the grip 208 and allow the spring 198 and gravity to move the cam 190 back to the retaining position. The coring probe 110 is suitably discarded. After the used coring probe 110 is discarded, the user can insert another coring probe 110 into the system and repeat the process to obtain another frozen sample core from frozen sample 104 or from another frozen sample.

It is understood that the above description describes one embodiment of the system, and several variations are within the scope of the present invention. Each of these variations can be used alone or in combination with any number of the above-described features.

For example, other configurations and devices for producing relative movement between the coring bit and the frozen sample are within the scope of the present invention. The carriage can be configured for manual movement relative to the frozen sample. The drive system can be operatively associated with the frozen sample container to move the frozen sample container relative to the coring bit, as an alternative to moving the coring bit. Moreover, the drive system can include a fully automated system allowing the drive system to repeatedly select frozen samples from a group of frozen samples, obtain a frozen sample core from the selected frozen sample, and deposit the frozen sample core in a destination container. For example, the drive system can include any of the following types of systems: (θ, Z) ; (θ, r, z) ; (x, Z) ; (x, y) ; (x, y, z). Moreover, any functions of the drive system and any combinations there can be performed manually, up to and including a fully manual system, within the broad scope of the invention.

Other configurations for directing electromagnetic radiation through the plunger are within the scope of the present invention. The plunger need not include the bore to permit electromagnetic radiation to pass through the plunger to reach the frozen sample to produce the display. The plunger can be transparent so that the laser directs the beam of light through the plunger to produce the display on the frozen sample. The plunger can comprise a waveguide for directing the beam of light through the plunger to produce the display on the frozen sample. If the plunger is a waveguide, the plunger can also include a lens (not shown) for collimating the beam of light from the laser. Moreover, the plunger can be omitted within the broad scope of the invention. For example, a pressurized gas system can be used to eject the frozen sample core from the coring bit. The plunger can also be part of a fill-level detection system adapted to detect the upper surface of the frozen sample, as described in commonly-owned U.S. application Ser. No. 13/359,301, filed Jan. 26, 2012, entitled Robotic End Effector for Frozen Aliquotter and Methods of Taking a Frozen Aliquot from Biological Samples, the entire contents are hereby incorporated by reference.

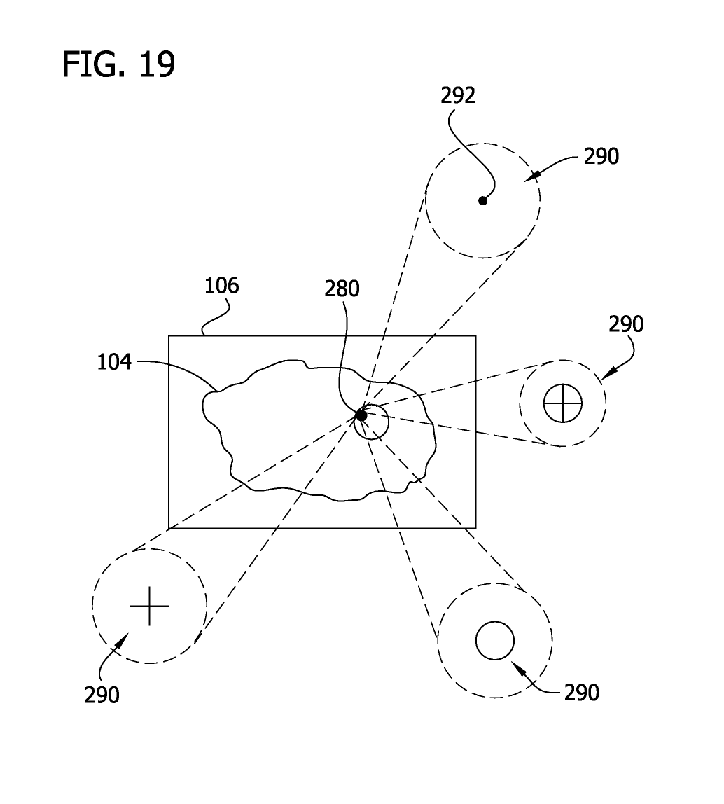

Other displays and patterns on the frozen sample are also within the scope of the present invention. The pattern can include an arc having a center of curvature substantially coincident with the intersection of the coring bit path and the frozen biological sample, as illustrated in FIG. 19. As further illustrated in FIG. 19, the pattern 290 can include intersecting lines (e.g., a cross-hair). The pattern can include an image projected on the sample by a projector.

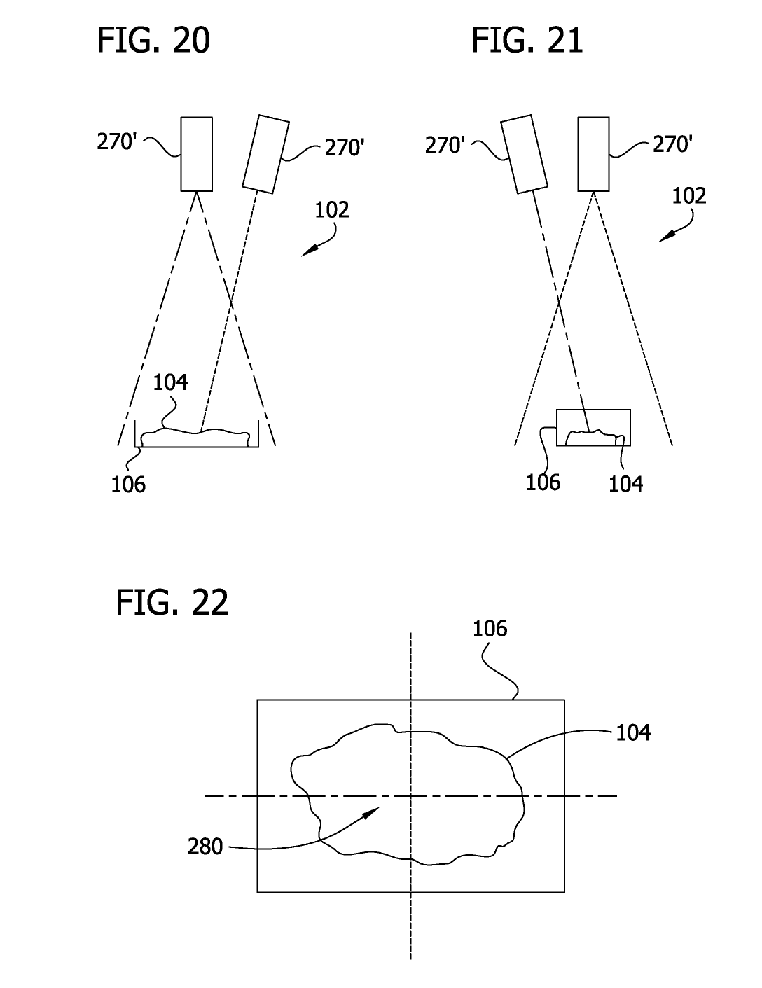

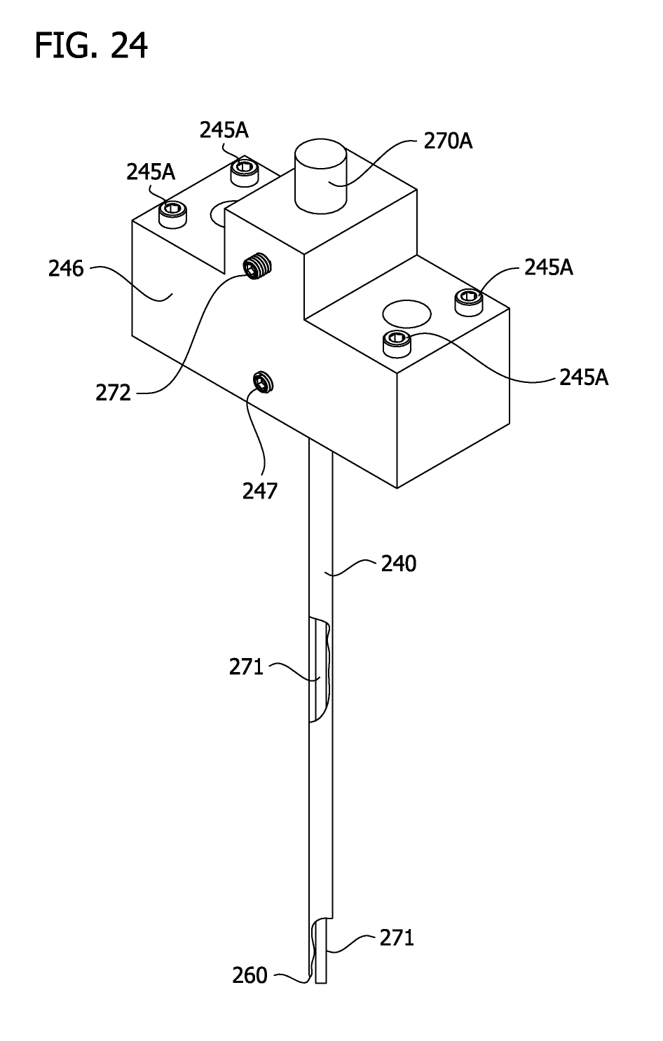

Other configurations for producing a display on the frozen sample indicating where the path of the coring bit intersects the frozen sample are within the scope of the present invention. For example, the targeting system can include a light source other than a laser directing light at the frozen sample. For instance, the targeting system can include a projector operable to project an image (e.g., an image of a targeting reticule) on the frozen sample. In another example, the targeting system can include a pair of line generators 270′ (e.g., laser line generators) mounted at fixed positions above the sample and adapted to produce a cross-hair display on the frozen sample (see FIGS. 20-22). In yet another example, the targeting system can include a fiber optic coupled laser 270A including an optical fiber 271 (FIG. 24). The fiber optic coupled laser could be mounted on the system 100 such that a distal end of the fiber 271 is disposed near the distal end 260 of the plunger 240. In this embodiment, the optical fiber 271 functions as a waveguide such that light from the fiber optic laser 270A is emitted near the distal end 260 of the plunger 240 rather than at the proximal end of the plunger as disclosed above for the laser 270.

The coring probe need not block the display from being produced on the frozen sample when the probe is received in the coring bit mount. It is understood that the display being produced on the frozen sample when the coring probe is attached to the coring bit mount is within the scope of the present invention. The ejector can include a bore so the beam of light from the laser is not blocked by the ejector. The coring probe may not include an ejector, and the laser can direct the beam of light through the hollow center of the coring bit. If the coring probe does not include an ejector, the plunger can be used to eject the frozen sample core from the coring bit. The ejector can comprise a waveguide for directing the beam of light through the ejector to produce the display on the frozen sample. If the ejector is a waveguide, the ejector can also include a lens (not shown) for collimating the beam of light from the laser.

Other configurations and devices for producing relative movement between the plunger and the coring probe are within the scope of the present invention. For instance, the plunger can be configured for movement by a separate actuator, instead of remaining fixed relative to the support 132.

Moreover, the ejector of the coring probe can be actuated without any plunger. For example, the ejection system can use compressed gas to move the ejector of a coring-probe, such as a single use coring probe, from the retracted position to the extended position.

It is also understood that various other couplings can be used to secure a coring bit to a system for using the coring bit. For example, the coupling can be designed to maintain a substantial void space between the coring bit and the system to which it is coupled. The void space can be an air-filled gap or if desired may be a vacuum-filled gap to limit transfer of heat between the coring bit and the system. For example, a pair of sealing members (e.g., O-rings) can be positioned on the coring bit and spaced apart from one other. The sealing members can seal against the system when the coring probe is connected to the system and maintain a gap between the coring bit and the system along the length of the coring bit between the sealing members to limit heat transfer between the coring bit and the system.

Also, the system can include an automated system for coupling and decoupling the coring probes from the coring bit mount. For example, the drive system can move the carriage down while the grip of the cam is engaged with a fixed object (e.g., a surface) to move the cam to its non-retaining position to connect and/or disconnect the coring probe from the coring bit mount.

It is also recognized that the frozen core can be ejected into a warm container within the scope of the present invention (e.g., if the core is going to be subjected to tests immediately). It is understood that the coring probe 110 need not include an ejector, and other configurations for ejecting a frozen sample core from the coring bit 112 are within the scope of the present invention.

When introducing elements of the present invention of the preferred embodiments thereof, the articles “a”, “an”, “the”, and “said” are intended to mean that there are one or more of the elements. The terms “comprising”, “including”, and “having” are intended to be inclusive and mean that there may be additional elements other than the listed elements.

In view of the foregoing, it will be seen that the several objects of the invention are achieved and other advantageous results attained.

As various changes could be made in the above constructions without departing from the scope of the invention, it is intended that all matter contained in the above description and shown in the accompanying drawings shall be interpreted as illustrative and not in a limiting sense.

1. A system for taking frozen sample cores from frozen biological samples, the system comprising:
a coring bit mount adapted to hold a coring bit;
a carriage supporting the coring bit mount;
a drive system adapted to produce relative movement between the carriage and the frozen biological samples for moving the coring bit along a path into the frozen biological samples;
a cutting action motor supported by the carriage and adapted to drive a cutting motion of the coring bit as the drive system drives the coring bit into the frozen biological samples to obtain a frozen sample core;
a targeting system adapted to direct electromagnetic radiation onto one of the frozen biological samples when said sample is positioned in the path of the coring bit, wherein the electromagnetic radiation is adapted to produce a display on the frozen biological sample indicating where the path of the coring bit intersects the frozen biological sample.

2. A system as set forth in claim 1 wherein the drive system comprises a manually-operated actuator operable by a person to produce said relative movement between the carriage and the frozen biological samples.

3. A system as set forth in claim 1 wherein the drive system is part of a robotic positioning system operable to produce said relative movement between the carriage and the frozen biological samples.

4. A system as set forth in claim 1 wherein the electromagnetic radiation is adapted so the display comprises a pattern centered on the intersection of the coring bit path with the frozen biological sample.

5. A system as set forth in claim 4 wherein the pattern comprises an arc having a center of curvature substantially coincident with the intersection of the coring bit path with the frozen biological sample.

6. A system as set forth in claim 4 wherein the pattern comprises a spot that is substantially coincident with the intersection of the coring bit path with the frozen biological sample

7. A system as set forth in claim 1 wherein the cutting action motor is adapted to produce a linear oscillatory motion of the coring bit.

8. A system as set forth in claim 1 wherein the coring bit mount comprises a spindle and the cutting action motor is adapted to rotate the spindle so the cutting action motor is operable to produce a rotary cutting action of the coring bit when it is connected to the spindle, the targeting system being adapted to direct electromagnetic radiation through the spindle.

9. A system as set forth in claim 8 wherein the coring bit mount is adapted to hold the coring bit so the coring bit extends along a coring bit axis, the targeting system comprising a laser positioned to direct a beam of said electromagnetic radiation along the coring bit axis to said frozen biological sample.

10. A system as set forth in claim 9 wherein the coring bit mount is positioned to hold the coring bit between the laser and the frozen biological sample so the coring bit is held in the path of said beam of electromagnetic radiation.

11. A system as set forth in claim 1 in combination with the coring bit, the coring bit being a single-use coring bit configured so use of the coring bit to obtain a frozen sample core converts the coring bit to a state in which the coring bit is not suitable for use obtaining another frozen sample core.

12. A system as set forth in claim 1, further comprising an ejection system for ejecting the frozen sample core from the coring bit, the ejection system comprising a plunger and a system for moving the plunger relative to the coring bit to eject the frozen sample core from the coring bit, the plunger having a hollow center for passage of said electromagnetic radiation through the plunger.

13. A system as set forth in claim 1, further comprising an ejection system for ejecting the frozen sample core from the coring bit, the ejection system comprising a plunger and a system for moving the plunger relative to the coring bit to eject the frozen sample core from the coring bit, the plunger comprising a waveguide for guiding electromagnetic radiation through the plunger.

14. A system as set forth in any claim 1, further comprising an ejection system for ejecting the frozen sample core from the coring bit, the ejection system comprising a plunger and a system for moving the plunger relative to the coring bit to eject the frozen sample core from the coring bit, wherein the plunger is transparent or translucent to the electromagnetic radiation to permit passage of electromagnetic radiation through the plunger.

15. A system as set forth in claim 1, further comprising an ejection system for ejecting the frozen sample core from the coring bit, the ejection system being adapted to eject the frozen sample core from the coring bit using a compressed gas.

16. A system as set forth in claim 1 in combination with a hollow coring bit, the targeting system comprising a laser adapted to direct a beam of electromagnetic radiation through the hollow center of the coring bit.

17. A system as set forth in claim 1 further comprising a support and a mounting block connected to the support for mounting one or more components of the targeting system on the support, the mounting block being angularly adjustable relative to the support for adjusting alignment of the targeting system.

18. A system as set forth in claim 1 wherein the targeting system comprises a laser and an optical fiber coupled to the laser.

19. A method of taking frozen sample cores from frozen biological samples using a system that drives one or more coring bits into the samples and then withdraws the one or more coring bits from the samples while a frozen sample core is retained in the one or more coring bits, the method comprising:
(a) positioning one of the frozen biological samples into a coring bit path along which the system moves the one or more coring bits;
(b) directing electromagnetic radiation onto the frozen biological sample, wherein the electromagnetic radiation is adapted to produce a display on the frozen biological sample indicating a position on the frozen sample where the coring bit path intersects the frozen biological sample;
(c) confirming that the position where the coring bit path intersects the frozen biological sample, as indicated by the display, is at a location on the sample from which a frozen sample core is desired;
(d) driving the coring bit into the frozen sample along the coring bit path; and
(e) withdrawing the coring bit from the frozen sample while a frozen sample core is retained in the coring bit.

20. The method of claim 19, further comprising moving the frozen sample relative to the coring bit path to reduce a difference between the position where the display indicates the coring bit path intersects the frozen sample and the location on the sample from which the frozen sample core is desired.

21-58. (canceled)
